(19) United States
(12) Patent Application Publication
(10) Pub. No.: US 2014/0213738 A1
(43) Pub. Date: Jul. 31, 2014

(54) POLY(ESTER AMIDE)S AND POLY(ESTER ETHER AMIDE)S WITH ALIPHATIC POLYESTERS, METHOD OF MAKING SAME, AND USES THEREOF

(71) Applicants: Chih-Chang Chu, Ithaca, NY (US); Jun Wu, Boston, MA (US); Kai Guo, Waltham, MA (US)

(72) Inventors: Chih-Chang Chu, Ithaca, NY (US); Jun Wu, Boston, MA (US); Kai Guo, Waltham, MA (US)

(73) Assignee: CORNELL UNIVERSITY, Ithaca, NY (US)

(21) Appl. No.: 14/342,144

(22) PCT Filed: Sep. 3, 2012
(86) PCT No.: PCT/US2012/053588

§ 371 Date: Feb. 28, 2014

Related U.S. Application Data
(60) Provisional application No. 61/530,526, filed on Sep. 2, 2011.

(51) Int. Cl. C08G 69/44

(52) U.S. Cl. CPC C08G 69/44
USPC 525/420

(57) ABSTRACT

Polymers and copolymers having one or more aliphatic polyester groups or blocks. For example, the aliphatic polyester groups or blocks can be derived from a caprolactone such as, for example, ε-caprolactone. The polymers and copolymers can have desirable properties such as, for example, improved solubility and improved thermal properties.

### CROSS-REFERENCE TO RELATED APPLICATIONS

This application claims priority to U.S. provisional patent application No. 61/530,526, filed Sep. 2, 2011, the disclosure of which is incorporated herein by reference.

### FIELD OF THE INVENTION

The present invention generally relates to preparation and use of poly(ester amide)s and poly(ester ether amide)s that have aliphatic polyesters.

### BACKGROUND OF THE INVENTION

In the past several decades, many absorbable and biocompatible polymers have been developed for the biotechnology and pharmaceutical industries. Among them, absorbable aliphatic polyesters like polylactide, polyglycolide, poly(ε-caprolactone) and their copolymers are the most well-known and widely used because of their biocompatibility, degradability, and consistent mechanical and processing properties. Although these FDA approved absorbable aliphatic polyesters have been widely used as scaffolds in tissue engineering, drug delivery vehicles, and surgical implants; the rapid development of biotechnology needs new generation polyesters or their derivatives with improved or expanded physicochemical, biological, and mechanical properties.

In recent years, many new aliphatic polyester derivatives have been prepared to meet the increasing demands of biomedical field. One such new approach is the incorporation of polyether segment into aliphatic polyesters like polyester-b-polyether (e.g., PLA-b-PEG) which have been widely investigated in the areas of antibiofouling, self-assembly, drug/gene delivery and nanotechnology. Another interesting approach is to introduce the natural amino acids into these aliphatic polyester backbones. The incorporation of natural amino acids would bring these aliphatic polyesters many new properties, such as functionality and charge property. One example of this approach is polyester-b-poly(amino acid)s, such as PLA-b-PLL and PCL-b-PLL, which have been widely used as drug delivery vehicles and tissue engineering scaffolds. However, after such a modification, many of aliphatic polyester derivatives or copolymers lost most of their original properties, especially the very important mechanical and processing properties, which largely limited their applications.

### BRIEF SUMMARY OF THE INVENTION

The present invention provides polymers and copolymers that have one or more aliphatic polyester (APE) groups or blocks. Also provided are methods of making such polymers, and uses thereof. The polymers and copolymers exhibit improved properties.

In an embodiment, the aliphatic polyester group(s) is/are part of the ether ester amide repeat unit of a poly(ether ester amide) (PEAA). The aliphatic polyester group is a low molecular weight aliphatic polyester. In another embodiment, a copolymer comprises one or more aliphatic polyester groups and poly(ester amide) (PEA) blocks.

The polymers and copolymers have desirable properties. The polymers and copolymers can be used in a variety of applications such as, for example, biomedical applications, pharmaceutical applications, and advanced materials.

### BRIEF DESCRIPTION OF THE FIGURES

FIG. 1. Scheme 1. Example of di-p-nitrophenyl esters of dicarboxylic acids as monomer I.

FIG. 2. Scheme 2. Example of synthesis of di-p-toluenesulfonic acid salts of bis-L-phenylalanine polycaprolactone ester (Phe-PCL) as monomer II. PCL-diol, Mₙ˜530 or 1250 g/mol.

FIG. 3. Example of synthesis of saturated and unsaturated polycaprolactone and L-phenylalanine-based poly(ether ester amide)s.

FIG. 4. FTIR spectra of two representative PCL-based poly(ether ester amide)s, SP-PCL530 and FP-PCL530.

FIG. 5. Representative ¹H NMR spectra of three PCL-based poly(ether ester amide)s in DMSO solvent: AP-PCL530, SP-PCL530 and FP-PCL530.

FIG. 6. Representative ¹³C NMR spectra of three PCL-based poly(ether ester amide)s in DMSO solvent: AP-PCL530, SP-PCL530 and FP-PCL530.

FIG. 7. Example of generic chemical structure of a poly(ester amide).

FIG. 8. Example of synthesis of Monomer I: Di-p-nitrophenyl Ester of Dicarboxylic Acids.

FIG. 9. Example of synthesis of Monomer II: Di-p-toluenesulfonic Acid salt of Bis(L-Phenylalanine)Alkylene Diesters.

FIG. 10. Example of synthesis of PEAs via solution polycondensation of monomers I and II.

FIG. 11. Example of synthesis of PEA-b-PCL from the ring-opening polymerization of ε-caprolactone via the macro-initiator, H₂N-PEA-NH₂.

FIG. 12. Representative ¹H-NMR spectrum of 8-Phe-4-b-PCL synthesized from 8-Phe-4 of Mₙ 4,000 and 8-Phe-4/ε-CL=1.0:1.0, w/w).

FIG. 13. Example of the effect of ε-caprolactone (CL) to PEA feed ratio on the melting temperature (Tₘ) of PEA-b-PCL copolymers.

FIG. 14. Representative SEM image of PEA-b-PCL microspheres. The PEA was from of Mₙ of 4,000, and the feed weight ratio of 8-Phe-4/ε-CL was 1:6, w/w).

FIG. 15. Representative SEM image of PEA-b-PCL eleetrospun fibers. The PEA was from 8-Phe-4, of Mₙ 4,000, and the feed weight ratio of 8-Phe-4/ε-CL was 1:6, w/w.

FIG. 16. Example of effect of PEA to PCL feed ratio on the enzymatic biodegradation of the PEA-b-PCL copolymers. Pure PEA and PCL served as the controls. 8-Phe-4 (Mₙ=30,000), PCL (Mₙ=80,000), 8-Phe-4-b-PCL (Mₙ of 8-Phe-4: 4,000; PEA/ε-CL=1:3, w/w), 8-Phe-4-b-PCL (Mₙ of 8-Phe-4: 4,000; PEA/ε-CL=1:6, w/w). Enzyme solution is 0.2 mg/mL of α-chymotryps in PBS solution.

FIG. 17. Representative microscopy image of attached BAEC on the copolymer coatings on glass coverslips for 96 hours: (a) PCL; (b) PEA/PCL mixture (1:3; w/w) (PEA: 8-Phe-4, Mₙ=30,000); (c) PEA/PCL mixture (1:6; w/w) (PEA: 8-Phe-4, Mₙ=30,000); (d) PEA-b-PCL copolymer (PEA/ε-CL=1:3; w/w) (PEA: 8-Phe-4, Mₙ=4,000); (e) PEA-b-PCL copolymer (PEA/ε-CL=1:6; w/w) (PEA: 8-Phe-4, Mₙ=4,000); (f) PEA (8-Phe-4, Mₙ=30,000).

FIG. 18. Example of MTT proliferation assay of BAEC on copolymer coatings on glass coverslips (a) PCL; (b) PEA/PCL mixture (1:3; w/w) (PEA: 8-Phe-4, Mₙ=30,000); (c) PEA/PCL mixture (1:6; w/w) (PEA: 8-Phe-4, Mₙ=30,000); (d) PEA-b-PCL copolymer (PEA/ε-CL=1:3; w/w) (PEA: 8-Phe-4, Mₙ=4,000); (e) PEA-b-PCL copolymer (PEA/ε-CL=1:6; w/w) (PEA: 8-Phe-4, Mₙ=4,000); (f) PEA (8-Phe-4, Mₙ=30,000).

FIG. 19. Example of in vitro measurement of inflammatory response of copolymers. J774 mouse macrophages were seeded on the polymer film to interact with the polymers. The mouse TNF-α production concentration was measured as an index of the inflammatory response. Blank control has no cells and negative control (NC) has the J774 mouse macrophages without any polymer treatment. LPS is the lipopolysaccharide.

FIG. 20. Example of reaction scheme for preparation of PEA-b-PCL copolymer.

FIG. 21. Example of PEA with 2 free amine end groups (H₂N-PEA-NH₂), where r<1.00(r=N_{NS}/N_{PB}); x=4, y=1 (SPB 8-Phe-4).

FIG. 22. Example of PEA with 1 free amine end group (PEA-NH₂), where r=1.00 (r=N_{NS}/N_{PB}); x=4, y=1 (SPB 8-Phe-4).

FIG. 23. Example of effect of r value and reaction time on PEA MW. SPB (8-Phe-4), 8-Phe-4: 8-Phe-4(0.8) (NS:PB=0.80:1.00, mol/mol, r=0.8), Low MW PEA macromer type: H₂N-PEA-NH₂, MW around 4-5 kD when r=0.8.

FIG. 24. Example of effect of r value and reaction time on PEA MW. SPB (8-Phe-4), 8-Phe-4: 8-Phe-4(0.9)(NS:PB=0.90:1.00, mol/mol, r=0.9), Low MW PEA macromer type: H₂N-PEA-NH₂, MW00 7-9 kD when r=0.9.

FIG. 25. Example of effect of r value and reaction time on PEA MW. SPB (8-Phe-4), 8-Phe-4: 8-Phe-4(1.0)(NS:PB=1.00:1.00, mol/mol, r=1.0), PEA-NH₂ macromer MW can be around 10-15 kD after 0.5-1 h.

FIG. 26. Representative Fourier transform infrared (FTIR) spectrum of PCL-Phe-PCL. PCL-8-Phe-4-PCL (r=0.8 for 8-Phe-4, W_{PEA}/W_{CL}=1:1.1, w/w).

FIG. 27. Example of MW-Time curve of PCL-8-Phe-4(3.6 k)-PCL(W/W:1/6.5).

FIG. 28. Example of Effect of Reaction Time on MW of PCL-8-Phe-4(8 k)-PCL. 8-Phe-4 to CL feed weight ratio: 1/6.

FIG. 29. Representative scanning electron microscope (SEM) images of microspheres fabricated from PCL-PEA-PCL. PEA-b-PCL: PCL-8-Phe-4(8K)-PCL with feed weight ratio of Phe macromer to PCL monomers @1:6. Formulation Condition: 1 wt % PVA in 100 ml water, 10 wt % polymer in 10 ml CHCl₃.

FIG. 30. Example of Phe-b-PLA copolymers. PEA macromer: x-Phe-y, with x and y are the # of CH₂ units in the diacid and diol parts, respectively. Phe can be replaced by other amino acids. n and m are the numbers of the repeating units for PEA and PLA blocks, respectively.

FIG. 31. Example of chemical reaction scheme for synthesis of PEA-b-PLA.

FIG. 32. Example of unsaturated PEA-b-APE Copolymers. UPEA-b-PCL. Phe can be replaced by other amino acids. n and m are the numbers of the repeating units for UPEA and PCL blocks, respectively.

FIG. 33. Example of UPEA-b-APE chemical reaction scheme.

FIG. 34. Example of a of PEA-b-PCL copolymer (UPEA-b-PCL (UPEA: SFPB)).

### DETAILED DESCRIPTION OF THE INVENTION

The present invention provides polymers and copolymers that have one or more aliphatic polyester (APE) groups or blocks (e.g., poly(ε-caprolactone) (PCL) groups or blocks). In the case of polymers, the aliphatic polyester group is part of the ether ester amide repeat unit of a poly(ether ester amide) (PEAA). In the case of copolymers, the copolymers comprise one or more aliphatic polyester groups and poly(ester amide) (PEA) blocks. Also provided are methods of making such polymers, and uses thereof.

The present invention is based, at least in part, on the surprising result that PEA-APE copolymers could be formed where the PEA block has a molecular weight of 10,000 g/mol or less and at least one end group that is an NH₂ group. Accordingly, in an embodiment, the present invention provides a PEA-APE copolymer where the PEA block has a molecular weight of 10,000 g/mol or less and at least one end group that is an NH₂ group.

As used herein, unless otherwise expressly stated, “alkyl” refers to branched or unbranched hydrocarbon groups. The alkyl group can be unsubstituted or substituted with one or more groups such as, for example, halides (—Cl, —Fl, —I, and —Br), nitro groups, amino groups (e.g., alkylamino and dialkylamino groups), alkoxide groups (e.g., C₁ to C₈ alkoxy groups), ether groups (e.g., C₁ to C₈ ether groups), ester (e.g., C₁ to C₈ ester groups) groups, carbocyclic groups, and heterocyclic groups.

As used herein unless otherwise expressly stated, “alkenyl” refers to branched or unbranched hydrocarbon groups having one or more carbon-carbon double bonds. The alkenyl group can be unsubstituted or substituted with one or more groups such as, for example, halides (—Cl, —Fl, —I, and —Br), nitro groups, alkoxide groups (e.g., C₁ to C₈ alkoxy groups), ether groups (e.g., C₁ to C₈ ether groups), ester groups (e.g., C₁ to C₈ ester groups), carbocyclic groups, and heterocyclic groups.

As used herein, unless otherwise expressly stated, “alkynyl” refers to branched or unbranched hydrocarbon groups having one or more carbon-carbon triple bonds. The alkenyl group can be unsubstituted or substituted with one or more groups such as, for example, halides (—Cl, —Fl, —I, and —Br), nitro groups, alkoxide groups (e.g., C₁ to C₈ alkoxy groups), ether groups (e.g., C₁ to C₈ ether groups), ester groups (e.g., C₁ to C₈ ester groups), carbocyclic groups, and heterocyclic groups.

As used herein, unless otherwise expressly stated, “carbocyclic group” refers to a cyclic compound having a ring in which all of the atoms forming the ring are carbon atoms. The carbocyclic group can be aromatic or nonaromatic, and include compounds that are saturated, partially unsaturated, or fully unsaturated. The carbocyclic group can contain one or more rings. Examples of such groups include phenyl, substituted phenyl rings (aryl, halides, alkyl chains in ortho, meta, para, or combinations thereof), and cycloalkyl rings such as (e.g., cyclohexyl and cyclopentyl rings). For example, the carbocyclic ring can be C₃ to C₁₂, including all integer numbers of carbons and ranges of numbers of carbons therebetween. The carbocyclic ring can be unsubstituted or substituted with groups such as, halides (—Cl, —Fl, —I, and —Br), alkenes, alkyl groups, aryl groups, or alkoxides. As used herein, unless otherwise expressly stated, “aryl group” refers to a “carbocyclic group” that is aromatic. The aryl group can be substituted in the same manner as the carbocylic group.

As used herein, unless otherwise expressly stated, “heterocyclic group” refers to a cyclic compound having one or more rings where at least one of the atoms forming the ring(s) is a heteroatom (e.g., O, N, S, etc.). The heterocyclic group can be aromatic or nonaromatic, and include compounds that are saturated, partially unsaturated, and fully unsaturated. For example, the heterocyclic group can be a C₃ to C₁₂ group, including all integer numbers of carbons and ranges of numbers of carbons therebetween. The heterocyclic ring can be unsubstituted or substituted with groups such as, for example, halides (—Cl, —Fl, —I, and —Br), alkyl groups, alkenyl groups, alkynyl groups, and alkoxides. As used herein, unless otherwise expressly stated, “heteroaryl group” refers to a “heterocylic group” that is aromatic. The heteroaryl group can be substituted in the same manner as the heterocylic group.

As used herein, unless otherwise expressly stated, the term “amino acid” refers to a natural amino acid residue (e.g., Ala, Arg, Asn, Asp, Cys, Glu, Gln, Gly, His, Ile, Leu, Lys, Met, Phe, Pro, Ser, Thr, Trp, Tyr, and Val) in D or L form, as well as unnatural amino acid (e.g., phosphoserine; phosphotireonine; phosphotyrosine; hydroxyproline; gamma-carboxyglutamate; hippuric acid; octahydroindole-2-carboxylic acid; statine; 1,2,3,4,-tetrahydroisoquinoline-3-carboxylic acid; penicillamine; ornithine; citruline; α-methyl-alanine; para-benzoylphenylalanine; phenylglycine; propargylglycine; sarcosine; and tert-butylglycine) residue having one or more open valences.

The term “amino acid” also includes natural and unnatural amino acids bearing amino protecting groups (e.g., acetyl, acyl, trifluoroacetyl, or benzyloxycarbonyl), as well as natural and urmatural amino acids protected at carboxy with protecting groups (e.g., as a (C₁-C₆) alkyl phenyl or benzyl ester or amide). Other suitable amino and carboxy protecting groups are known to those skilled in the art (See, for example, see Wuts et al., Greene's. Protective Groups in Organic Synthesis, 4th Edition, 2006; L. Stryer, Biochemistry, (3rd Ed), W.H. Freeman and Co.: New York, 1975; J. March, Advanced Organic Chemistry, Reactions, Mechanisms and Structure, (2nd Ed.), McGraw Hill: New York, 1977; F. Carey and R. Sundberg, Advanced Organic Chemistry, Part B; Reactions and Synthesis, (2nd Ed.), Plenum: New York, 1977; and references cited therein).

The term “amino acid” also includes alpha amino acids and beta amino acids. Alpha amino acids include monocarboxylic monoamino acids, dicarboxylic monoamino acids, polyamino acids and heterocyclic amino acids. Examples of monocarboxylic monoamino acids include glycine, alpha-phenylglycine, alpha-alanine, serine, valine, norvaline, beta-merceptovaline, threonine, cysteine, leucine, isoleucine, norleucine, N-methylleucine, beta-hydroxy leucine, methionine, phenylalanine, N-methylphenylalanine, pipecolic acid, sarcosine, selenocysteine, tyrosine, 3,5-diiodotyrosine, triiodothyronine, and thyroxine.

Examples of monoamino dicarboxylic acids and amides include aspartic acid, beta-methyl aspartic acid, glutamic acid, asparagine, alpha-aminoadipic acid, 4-ketopipecolic acid, lanthionine, and glutamine. Examples of polyamino acids include ornithine, lysine, 6-N-methyllysine, 5-hydroxylysine, desmosine, argmine and cystine. Examples of heterocyclic amino acids include proline, 4-hydroxyproline and histidine, and tryptophan. Examples of other alpha amino acids are gamma-carboxyglutamate and citrulline. The beta amino acids include, for example, beta-alanine.

As used herein, unless otherwise expressly stated, the term “molecular weight” refers to number averaged molecular weight (Mₙ) and/or weight averaged molecular weight (M_{w}).

In an aspect, the present invention provides copolymers comprising one or more aliphatic polyester (e.g., PCL) blocks. The copolymers are block copolymers.

In an embodiment, the block copolymer comprises one APE block or two APE blocks, and a PEA block. For example, the copolymer has the following structure:

PEA-APE or APE-PEA-APE.

The PEA blocks comprise a plurality of amino acid groups, which are derived from amino acid monomers. The amino acids can be the same or different amino acids.

In an embodiment, the copolymer has the following structure:

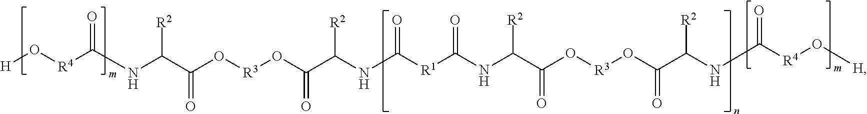

where n, at each occurrence in the copolymer, is an integer from 2 to 100, including all integer values and ranges therebetween, and m, at each occurrence in the copolymer, is an integer from 0 to 100, including all integer values and ranges therebetween. Based on the structures of R¹, R², R³, and R⁴, the values of n and m can be selected to provide a copolymer having a molecular weight of from 2000 g/mol to 100,000 g/mol, including all values to the 100 g/mol and ranges therebetween.

R¹ at each occurrence in the copolymer is an alkyl group or alkenyl group comprising 2 to 20 carbons, including all integers and ranges therebetween. R¹ is also referred to as a “diacid residue” because, for example, it can be derived from a monomer prepared from a diacid.

R² at each occurrence in the copolymer is a hydrogen, alkyl group comprising 2 to 8 carbons, including all integer number of carbons therebetween, alkenyl group comprising 2 to 8 carbons, including all integer number of carbons therebetween, alkynyl group comprising 2 to 8 carbons, including all integer number of carbons therebetween, carbocyclic group, where the carbocyclic ring comprises 3 to 8 carbons, including all integers therebetween, or alkyl amino group, where the alkyl moiety comprises 1 to 8 carbons, including all integer number of carbons therebetween. In an embodiment, R² at each occurrence in the copolymer is the side chain of an amino acid (e.g., the benzyl group of phenylalanine). The amino acid side chain is the group covalently bonded to a carbon atom (e.g., the alpha carbon or beta carbon of an amino acid) of an amino acid. For example, R², the carbon to which it bonded, the amine moiety, and carboxyl moiety adjacent to the carbon correspond to an amino acid from which R² is derived.

R³ at each occurrence in the polymer is an alkyl group comprising 2 to 8 carbons, including all integer number of carbons therebetween, alkenyl group comprising 2 to 8 carbons, including all integer number of carbons therebetween, or alkyl polyether group (where each individual alkyl moiety of the polyether comprises 1 to 8 carbons, including all integer number of carbons therebetween). R₃ is also referred to as a “diol residue” because, for example, it can be derived from a monomer prepared using a diol. The polyether group can be an poly(alkylether) group, where each alkyl moiety of the polyether group, independently at each occurrence in the group, comprises one or more methylene moieties. For example, R₃ can be an alkyl polyether group having the structure —(CH₂—CH₂—O)ⱼ—CH₂—CH₂— (which can be derived from oligo(ethylene glycol)), where j at each occurrence of R₃ is an integer from 1 to 100, including all integers and ranges therebetween.

R⁴ at each occurrence in the copolymer is an aliphatic group comprising 1 to 8 carbons, including all integer numbers of carbons therebetween. R⁴ can be derived from a ring opening polymerization of a caprolactone (e.g., ε-caprolactone), a cyclic diester (such as a lactide (e.g, L-lactide or D,L-lactide), or substituted analog thereof. R⁴ and the adjacent carbonyl and oxygen moieties taken together form an APE group.

In an embodiment, all R¹ groups in the copolymer are the same. In an embodiment, all R² groups in the copolymer are the same. In an embodiment, all R³ groups in the copolymer are the same. In an embodiment, all R⁴ groups in the copolymer are the same. In an embodiment, all the R¹ groups in the copolymer are the same, all the R² groups in the copolymer are the same, all the R³ groups in the copolymer are the same, and all the R⁴ groups in the copolymer are the same.

The following is an example of a block copolymer:

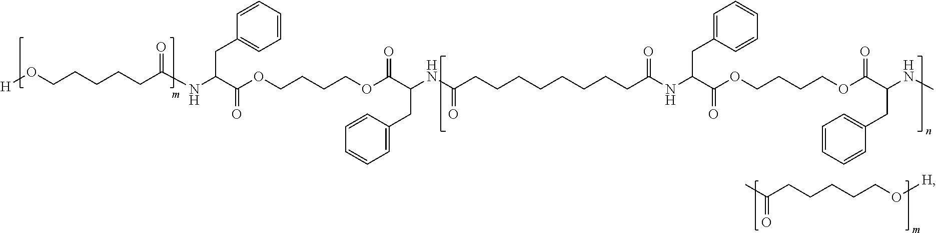

where m and n are as described above.

The copolymers can have a molecular weight of 2000 g/mol to 100,000 g/mol, including all values to the 100 g/mol and ranges therebetween. The PEA block of the copolymer has a molecular weight of less than 10,000 g/mol. In an embodiment, the molecular weight of the PEA block is 3,000 g/mol to 10,000 g/mol, including all values to the 100 g/mol and ranges therebetween.

In an embodiment, the polymer is a poly(ester ether amide) having one or more low molecular weight APE groups. In an embodiment, the polymer has a plurality of low molecular weight APE groups (e.g., PCL oligomers). By low molecular weight it is meant that the APE group independently at each occurrence in the polymer has a molecular weight of from (M_{w}, or Mₙ) of 100 g/mol to 2500 g/mol. In an embodiment, all of the APE groups have substantially the same molecular weight (i.e., +/−5% g/mol).

In an embodiment, the APE group is a PCL group. For example, the PCL group is a PCL-diol group having the following structure:

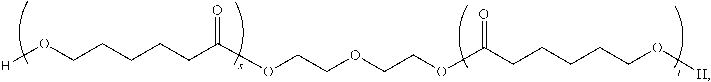

where s is, independently at each occurrence in the polymer, 1 to 15, including all integers and ranges therebetween, and t is, independently at each occurrence in the polymer, 1 to 15, including all integers and ranges therebetween.

In an embodiment, the polymer has the following structure:

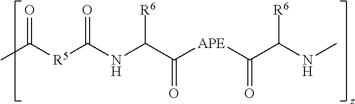

where z is an integer 2 to 100, including all integer values and ranges therebetween. Based on the structures of R⁵, R⁶, and APE, the value of z can be selected to provide a copolymer having a molecular weight of 2000 g/mol to 100,000 g/mol, including all values to the 100 g/mol and ranges therebetween.

In another embodiment, the polymer has the following structure:

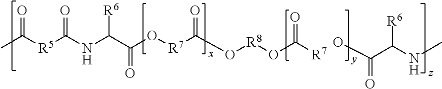

where x is an integer 1 to 100, including all integer values and ranges therebetween, and y is an integer 1 to 100, including all integer values and ranges therebetween, and z is an integer 1 to 100, including all integer values and ranges therebetween.

R⁵ at each occurrence in the polymer is as described above for R¹. R⁶ at each occurrence in the polymer is as described above for R². R⁷ at each occurrence in the copolymer is as an alkyl group. In an embodiment, R⁷ is an aliphatic group (e.g., —CH₂CH₂CH₂CH₂CH₂—). R⁸ at each occurrence in the copolymer is as an alkyl group or ether group. In an embodiment, the ether group is —(CH₂)₂—O—(CH₂)₂—.

For example, the polymer has the following structure:

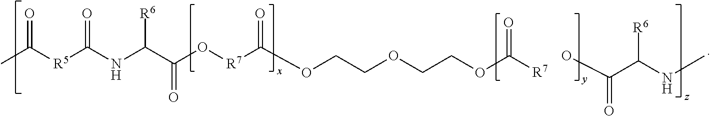

Each of the individual groups in the polymer can be the same. All of the individual groups in the polymer can be the same. In an embodiment, R⁵ groups in the polymer are the same. In an embodiment, all R⁶ groups in the polymer are the same. In an embodiment, all R⁷ groups in the polymer are the same. In an embodiment, all R⁸ groups in the polymer are the same. In an embodiment, all the R⁵ groups in the polymer are the same, all the R⁶ groups in the polymer are the same, all the R⁷ groups in the polymer are the same, and all the R⁸ groups in the polymer are the same.

The polymers can have a molecular weight of 2000 g/mol to 100,000 g/mol, including all integers and ranges therebetween. In an embodiment, the molecular weight of the polymer is 5000 g/mol to 50,000 g/mol, including all integers and ranges therebetween.

The end groups of the copolymer or polymer can be, independently, —OH or —H groups (e.g., forming amine groups or carboxylic acid groups). In an embodiment, both end groups are OH groups. In an embodiment, both end groups are —H groups. In an embodiment, one end group is a —OH group (e.g., an acid group) and the other end group is a —H group (e.g., an amine group).

The copolymers and polymers have desirable properties. For example, the copolymers and polymers can have improved solubility (e.g., water solubility), thermal properties (e.g., glass transition temperature (T_{g}) and melting point (Tₘ)), biodegradability (e.g., enzymatic biodegradation and hydrolytic degradation properties), biocompatabity (e.g., cell toxicity, inflammatory response, and cell proliferation behavior), bioadsorption, or a combination thereof relative to similar polymers or copolymers without such APE groups or blocks.

In an aspect the present invention provides methods of making the polymers and copolymers. The methods incorporate one or more aliphatic polyester blocks or groups into the copolymers and polymers.

In an embodiment, block copolymers are made by a method comprising the steps of:
a) mixing a first monomer having the following structure:

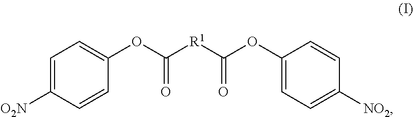

where R¹ is as described above, with a second monomer having the following structure:

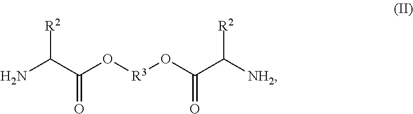

where R² and R³ are as described above and (II) can be present as a tosylate, in a ratio such that I:II is less than 1.0, and optionally a suitable solvent to form a reaction mixture; b) heating the reaction mixture for a time until polymerization has proceeded to the desired amount to form a PEA where at least one of the end groups of the PEA is an —NH₂ group, c) heating the PEA from b) at, for example, 40° C. to 175° C. with a catalyst and an cyclic ester, a cyclic diester until polymerization has proceeded to the desired amount.

The heating steps, steps b) and c), can be carried out, independently. For example, the heating steps can be carried out, independently, 0.5 to 30 hours. Heating step b) can be carried out for a particular time and temperature to form a PEA having a desired molecular weight. The heating steps can be carried out in an inert atmosphere (e.g., a nitrogen atmosphere).

The first monomer is a di-p-nitrophenyl ester of a dicarboxylic acid. A variety of dicarboxylic acids can be used to make the monomer. Methods for making the monomer are known in the art. Suitable materials used to make the monomer are commercially available. Methods for making suitable materials for making the monomers are known in the art.

The second monomer is a bis-(amino acid)-α,ω-dialkylene diester. A variety of such diesters can be used to make the monomer. Methods for making the monomer are known in the art. Suitable materials used to make the monomer are commercially available. Methods for making materials suitable to make the monomers are known in the art. The diester can be present as a salt (e.g., a p-toluene sulfonic acid salt).

A variety of cyclic ester (e.g., a caprolactone such as, for example, ε-caprolactone), a cyclic diester (e.g., a lactide (e.g, L-lactide or D,L-lactide), and substituted analogs thereof can be used. Suitable esters and diesters are commercially available. Methods for making suitable esters and diesters are known in the art.

The PEA has a molecular weight (M_{w} or Mₙ) of 10,000 g/mol or less. In an embodiment, the molecular weight (M_{w} or Mₙ) of the PEA is 3,000 g/mol to 10,000 g/mol, including all values to the 100 g/mol and ranges therebetween. In an embodiment, both of the end groups of the PEA are NH₂ groups. Without intending to be bound by any particular theory it is considered that the copolymers will not form if the PEAs has a molecular weight greater than 10,000 g/mol and do not have at least one end group that is an —NH₂ group. In an embodiment, both PEA end groups are —NH₂ groups. In another embodiment, one PEA end groups is a —NH₂ group.

Any catalyst that can catalyze the reaction of the PEA with a caprolactone (e.g., ε-caprolactone), a cyclic diester (such as a lactide (e.g, L-lactide or D,L-lactide), or substituted analog thereof can be used. The catalyst can be an Sn(II) catalyst such as, for example, Sn(Oct)₂

In an embodiment, a polymer having one or more aliphatic polyester groups are made by a method comprising the steps of:
a) mixing an amino acid (e.g., an amino acid having the following structure:

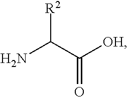

where R² is a described above) with a low molecular weight APE polymer (e.g., an APE polymer having the following structure:

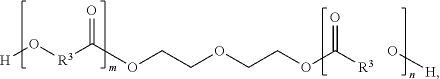

where R³, m and n are as described above), to form a first monomer;
b) heating the reaction mixture from a) at, for example, 40° C. to 175° C. such that the first monomer is formed,
c) mixing the first monomer and a second monomer having the following structure:

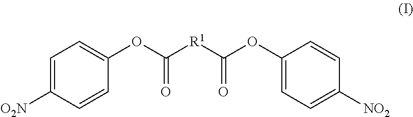

where R¹ is as described above, and, optionally, a suitable solvent, to form a reaction mixture;
d) heating the reaction mixture from c) at, for example, 50° C. to 150° C. until polymerization has proceeded to the desired amount forming a PEEA polymer having one or more aliphatic polyester groups.

The heating steps, steps b) and d), can be carried out, independently. For example, the heating steps can be carried out, independently, for 0.5 to 30 hours. The heating steps can be carried out in an inert atmosphere (e.g., a nitrogen atmosphere).

The second monomer (I) is a di-p-nitrophenyl ester of a dicarboxylic acid. A variety of dicarboxylic acids can be used to make the monomer. Methods for making the monomer are known in the art. Suitable materials used to make the monomer are commercially available. Methods for making suitable monomers are known in the art.

The APE polymer has a molecular weight of 200 g/mol to 3000 g/mol, including all values to the 10 g/mol and ranges therebetween.

In an aspect, the present invention provides compositions comprising the polymers and copolymers described herein. For example, the compositions can be used in biotechnology applications, biomedical applications, such as antibiofouling, and tissue engineering scaffolds, and pharmaceutical applications, such as drug/gene delivery, advanced materials applications, such as self-assembly and nanotechnology. One having skill in the art would recognize additional component(s) that may be added to the composition to achieve the desired result for the particular application.

The copolymers and polymers can be formed into a variety of shapes. In an embodiment, the copolymer or polymers are fibers. In another embodiment, the copolymer or polymers are microspheres. For example, the microspheres can be made using a double emulsion method that can be used to load water soluble drugs/proteins.

The following examples are presented to illustrate the present invention. They are not intended to limiting in any manner.

### EXAMPLE 1

This example provides a method for synthesis and characterization of poly-ε-caprolactone-containing amino acid-based poly(ether ester amide)s.

A new family of biodegradable amino acid-based poly(ether ester amide)s (AA-PEEAs) consisting of three building blocks [poly-ε-caprolactone (PCL), L-phenylalanine (Phe), and aliphatic acid dichloride] were synthesized by solution polycondensation. Using DMA as the solvent, these PCL-containing Phe-PEEA polymers were obtained with fair to very good yields with weight average molecular weight (M_{w}) ranging from 6.9 kg/mol to 31.0 kg/mol, depending on the original molecular weight of PCL. The chemical structures of the PCL-containing Phe-PEEA polymers were confirmed by IR and NMR spectra. These PCL-containing Phe-PEEAs had lower T_{g} than most of the oligoethylene glycol based AA-PEEAs due to the more molecular flexibility of the PCL block in the backbones, but had higher T_{g} than non-amino acid based PEEA. The solubility of the PCL-containing Phe-PEEA polymers in a wide range of common organic solvents, such as THF and chloroform, was significantly improved when comparing with aliphatic diol based poly(ester amide)s and oligoethylene glycol based AA-PEEAs.

In this example, a low molecular weight aliphatic polyester, poly(ε-caprolactone) (PCL), was used for the design and synthesis of a new family amino acid-based PEAs that could provide not only more flexible backbone chains but also hydrolytic degradation capability due to the presence of the PCL segment. By incorporating PCL block into the AA-PEA backbone chain, the PCL-containing AA-PEAs obtained have controllable PCL block with ether bonds, which can be used to balance the rigidity of the polymer backbone thus to improve the thermal properties of the AA-PEEA polymers.

A series of saturated and unsaturated PCL-containing L-phenylalanine-PEEAs (PCL-Phe-PEEA) were synthesized by solution polycondensation of unsaturated or saturated diester monomers and saturated PCL-based Phe diamine salts. The chemical structures of these PCL-Phe-PEEAs were confirmed by FTIR and NMR spectra. The molecular weight, molecular weight distribution (MWD), thermal property and solubility of the resulting PCL-Phe-PEEA polymers were examined as well.

Experimental. Materials. L-Phenylalanine (L-Phe), p-toluenesulfonic acid monohydrate (TosOH.H₂O), sebacoyl chloride, adipoyl chloride, fumaryl chloride (Alfa Aesar, Ward Hill, Mass.), polycaprolactone diol, (PCL-diol, Mₙ˜530 or 1250 g/mol, Aldrich) and p-nitrophenol (J. T. Baker, Phillipsburg, N.J.) were used without further purification. Triethylamine from Fisher Scientific (Fairlawn, N.J.) was dried by refluxing with calcium hydride, and then distilled. N,N-Dimethylforamide (DMF) from Aldrich Chemical Company (Milwaukee, Wis.) was dried over calcium hydride and distilled. Other solvents like benzene, trifluoroethanol (TFE), tetrahydrofuran (THF), ethyl acetate, acetone, acetonitrile, N,N-dimethylacetamide (DMA), and dimethyl sulfoxide (DMSO) were purchased from VWR Scientific (West Chester, Pa.) and were purified by standard methods before use.

Synthesis of monomers and polymers. The synthesis of PCL-based PEEAs involved the following three basic steps: (1) synthesis of three di-p-nitrophenyl esters of dicarboxylic acids (I), one of which was unsaturated and the other two were saturated; (2) synthesis of two di-p-toluenesulfonic acid salts of bis-L-phenylalanine esters (II) from PCL-diols; and (3) solution polycondensation of the monomers, (I) and (II), obtained in steps (1) and (2).

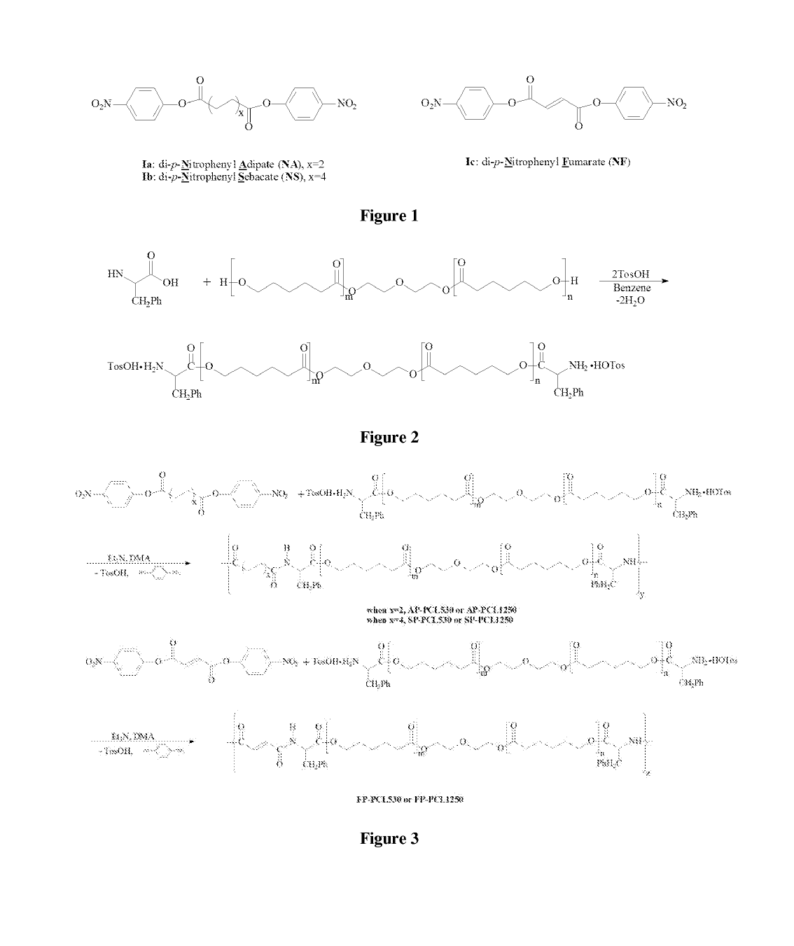

Synthesis of di-p-nitrophenyl esters of dicarboxylic acids (I). Three di-p-nitrophenyl esters of dicarboxylic acids (Ia, Ib and Ic, FIG. 1—Scheme 1) were prepared by reacting the corresponding dicarboxylic acyl chlorides with p-nitrophenol.

Synthesis of di-p-Toluenesulfonic Acid Salts of bis-L-Phenylalanine Esters (II). Di-p-toluenesulfonic acid salts of bis-L-phenylalanine esters were prepared as shown in FIG. 2—Scheme 2. Instead of using toluene as the solvent, benzene was used because the high boiling point of toluene may cause the decomposition of the reactants. Typically, L-Phe (0.176 mol), p-toluenesulfonic acid monohydrate (0.176 mol) and PCL-diols (0.08 mol) in 300 mL of benzene were placed in a flask equipped with a Dean-Stark apparatus, a CaCl₂ drying tube, and a magnetic stirrer. The solid-liquid reaction mixture was heated (c.a. 100° C.) to reflux for 16 hours till 6.1 mL (0.34 mol) of water evolved. The reaction mixture was then cooled to room temperature. After the solvent was removed by rotate evaporation, the mixture was dried in vacuo overnight and finally purified by recrystallization from 2-propanol for three times.

Phe-PCL530 and Phe-PCL1250: Recrystallized from 2-propanol. mp: 34° C. (Phe-PCL530); 44° C. (Phe-PCL1250). IR (cm⁻¹): 1737 [—C(O)—], 1177 (—O—), 1127 (—CH₂—O—CH₂—). ¹H NMR (DMSO-d₆, ppm, δ): 1.16 (—O—C₂H₄—CH₂—C₂H₄—), 1.29 (—O—CH₂—CH₂—C₃H₆—), 1.53 [—O—C₃H₆—CH₂—CH₂—], 2.27, [—O—C₄H₈—CH₂—C(O)—], 2.29 (H₃C-Ph-SO₃—), 3.05, 3.10 (PhCH₂—), 3.60 [—(O)C—O—CH₂—CH₂—O—], 3.98 [—O—CH₂—C₄H₈—C(O)—], 4.11 [⁺H₃N—CH(CH₂Ph)-], 4.31 [—(O)C—O—CH₂—CH₂—O—], 7.10˜7.44 (—CH₂-Ph), 7.46, 7.48 (H₃C-Ph-SO₃—), 8.37 [⁺H₃N—CH(CH₂Ph)-]. ¹³C NMR (DMSO-d₆, ppm, δ): 20.72 (H₃C-Ph-SO₃—), 24.05 [—O—C₃H₆—CH₂—CH₂—], 24.86 (—O—C₂H₄—CH₂—C₂H₄—), 27.77 (—O—CH₂—CH₂—C₃H₆—), 33.31 [—O—C₄H₈—CH₂—C(O)—], 36.11 (PhCH₂), 53.18 [⁺H₃N—CH(CH₂Ph)-], 63.44 [—O—CH₂—C₄H₈—C(O)—], 65.31 [—(O)C—O—CH₂—CH₂—O—], 68.17 [—(O)C—O—CH₂—CH₂—O‘3], 125.45, 127.17, 128.50, 137.76, (PhCH₂—), 128.05, 129.28, 134.57, 145.32 (H₃—CPh-), 169.04 [—CH—C(O)—], 172.67 (—C₅H₁₀—C(O)—O—].

Solution polycondensation of monomers I and II. PEEAs based on PCL-OH (linked by ether bond) were prepared by the solution polycondensation of di-p-toluenesulfonic acid diester salt (Phe-PCL530 or Phe-PCL1250) with one di-p-nitrophenyl ester (NA, NS or NF). The combinations tried in this example and their name designations are summarized in Table 1 and shown in Scheme 3. In Table 1, the designations of AA-PEEAs starting with F like FP-PCL530 or FP-PCL1250 were unsaturated AA-PEEAs with C═C double bonds in the diamide segment and the rest AA-PEEA designations were saturated.

An example of the synthesis of AP-PCL530 via a solution polycondensation is given below to illustrate the details of the synthesis procedures. Ten millimoles (1.42 mL) triethylamine was added dropwise to the mixture of monomers NA (Ia 4.0 mmol) and Phe-PCL530 (IIa 4.0 mmol) in 3 mL of dry DMA, and the solution was heated to 60° C. with stirring until a complete dissolution of monomers. The reaction vial was then kept at 70° C. for 48 hrs without stirring. The resulting viscous solutions were precipitated by different solvents, depending on fumaryl based polymer or non-fumaryl based polymer. For the fumaryl-based AA-PEEA polymer (FP-PCL530 and FP-PCL1250), the viscous solution was poured into chilled ethyl acetate to precipitate the product. The polymers were then filtered and extracted by ethyl acetate in a Soxhlet apparatus for 48 hours, and finally dried in vacuo for 48 hours. For the rest AA-PEEA polymers (non-fumarate-based), chilled ethyl ether was used as the precipitation solvent and then polymer was washed by ethyl ether twice, filtered and finally dried in vacuo for 48 hours before further study.

TABLE 1
Monomer combinations for PCL-based PEEA

Monomer II

| | | Phe-PCL530 | Phe-PCL1250 |
|---|---|---|---|
| Monomer I | NF | FP-PCL530 | FP-PCL1250 |
| | NA | AP-PCL530 | AP-PCL1250 |
| | NS | SP-PCL530 | SP-PCL1250 |

AP-PCL530/AP-PCL1250: IR (cm⁻¹), 1738 [C(O)—O—], 1643, 1532 [—C(O)—NH—], 1126 (—CH₂—O—CH₂—), 3306 [—C(O)—NH—]. ¹H NMR (DMSO-d₆, ppm, δ): 1.29 [—NH—(O)C—CH₂—CH₂—], 1.46 [—O—C₂H₄—C₂H₄—CH₂—], 1.76 [—O—C₄H₈—CH₂—], 1.99 [—NH—(O)C—CH₂—], 2.28 [—O—C₃H₆—CH₂—CH₂—], 2.94 [PhCH₂—], 3.56 [—(O)C—O—CH₂—CH₂—O—], 3.96 [—O—CH₂—C₄H₈—], 4.11 [—(O)C—O—CH₂—CH₂—O], 4.45 [—HN—CH(CH₂Ph)-], 7.19˜7.24 [-Ph], 8.24 [—HN—CH(CH₂Ph)-]. ¹³C NMR (DMSO-d₆, ppm, δ): 23.99 [—O—C₂H₄—CH₂—C₂H₄—], 24.04 [—O—C₃H₆—CH₂—CH₂—], 24.55 [—NH—(O)C—CH₂—CH₂—], 27.75 [—O—CH₂—CH₂—C₃H₆—], 33.30 [—O—C₄H₈—CH₂—], 34.63 [—NH—(O)C—CH₂—], 36.67 [PhCH₂—], 53.41 [—HN—CH(CH₂Ph)-], 63.46 [—(O)C—O—CH₂—CH₂—O—], 63.69 [—(O)C—O—CH₂C₄H₈—], 68.05 [—(O)C—O—CH₂—CH₂—O—], 126.42, 128.12, 128.99, 137.13 [-Ph], 166.12 [—(O)C—O—C₂H₄—O—], 171.65 [—(O)C—O—C₅H₁₀—], 172.10 [—C(O)—NH—].

SP-PCL530/SP-PCL1250: IR (cm⁻¹), 1736 [—C(O)—O—], 1645, 1530 [—C(O)—NH—], 1124 (—CH₂—O—CH₂—), 3309 [—C(O)—NH—]. ¹H NMR (DMSO-d₆, ppm, δ): 1.11 [—NH—(O)C—C₂H₄—C₂H₄—], 1.37 [—NH—(O)C—CH₂—CH₂—], 1.48 [—O—CH₂—C₂H₄—C₂H₄—], 2.01 [—O—C₄H₈—CH₂—], 2.03 [—NH—(O)C—CH₂—], 2.27 [—O—C₃H₆—CH₂—CH₂—], 2.94 [PhCH₂—], 3.54 [—(O)C—O—CH₂—CH₂—O—], 3.97 [—O—CH₂—C₄H₈—], 4.12 [—(O)C—O—CH₂—CH₂—O], 4.47 [—HN—CH(CH₂Ph)-], 7.18˜7.24 [-Ph], 8.23 [—HN—CH(CH₂Ph)-]. ^{—}C NMR (DMSO-d₆, ppm, δ): 23.99 [—O—C₂H₄—CH₂—C₂H₄—], 24.03 [—O—C₃H₆—CH₂—CH₂—], 25.10 [—NH—(O)C—CH₂—CH₂—], 27.75 [—O—CH₂—CH₂—C₃H₆—], 28.41 [—NH—(O)C—C₃H₆—CH₂—], 28.64 [—NH—(O)C—C₂H₄—CH₂—], 33.29 [—O—C₄H₈—CH₂—], 34.92 [—NH—(O)C—CH₂—], 36.62 [PhCH₂—], 53.35 [—HN—CH(CH₂Ph)-], 63.44 [—(O)C—O—CH₂—CH₂—O—], 63.69 [—(O)C—O—CH₂—], 68.08 [—(O)C—O—CH₂—CH₂—O—], 126.38, 128.07, 128.98, 137.19 [-Ph], 166.12 [—(O)C—O—C₂H₄—O—], 171.67 [—(O)C—O—C₅H₁₀—], 172.27 [—C(O)—NH—].

FP-PCL530/FP-PCL1250: IR (cm⁻¹), 1730 [—C(O)—O—], 1627, 1536 [—C(O)—NH—], 1120 (—CH₂—O—CH₂—), 3301 [—C(O)—NH—]. ¹H NMR (DMSO-d₆, ppm, δ): 1.15 [—O—C₂H₄—CH₂—C₂H₄—], 1.51 [—O—CH₂—CH₂—C₃H₆—], 1.99 [—O—C₄H₈—CH₂—], 2.29 [—O—C₃H₆—CH₂—CH₂—], 2.99 [PhCH₂—], 3.55 [—(O)C—O—CH₂—CH₂—O—], 3.98 [—O—CH₂—C₄H₈—], 4.14 [—(O)C—O—CH₂—CH₂—O—], 4.56 [—HN—CH(CH₂Ph)-], 6.83 [—C(O)—CH═], 7.20˜7.26 [-Ph], 8.88 [—HN—CH(CH₂Ph)-]. ¹³C NMR (DMSO-d₆, ppm, δ): 24.04 [OC₂H₄—CH₂—C₂H₄—], 24.84 [—O—C₃H₆—CH₂—CH₂—], 27.75 [—O—CH₂—CH₂—C₃H₆—], 33.30 [—O—C₄H₈—CH₂—], 36.57 [PhCH₂], 53.82 [—HN—CH(CH₂Ph)-], 63.44 [—(O)C—O—CH₂—CH₂—O—], 63.91 [—(O)C—O—CH₂—], 68.06 [—(O)C—O—CH₂—CH₂—O—], 126.56, 128.20, 128.99, 136.84 [-Ph], 132.51 [—C(O)—CH═], 163.51 [—C(O)—NH—]. 171.09 [—(O)C—O—C₂H₄—O—], 172.73 [—(O)C—O—C₅H₁₀—].

Materials Characterization. For Fourier transform infrared (FTIR) characterization, samples were ground into powder and mixed with KBr at a sample to KBr ratio of 1:10 w/w. FTIR spectra were then obtained from a Perkin-Elmer Nicolet Magana 560 (Madison, Wis.) FT-IR spectrometer with Omnic software for data acquisition and analysis.

NMR spectra were recorded by a Varian Unity INOVA-400 400 MHz spectrometer (Palo Alto, Calif.) operating at 400 and 100 MHz for ¹H and ¹³C NMR, respectively. Deuterated dimethyl sulfoxide (DMSO-d₆, Cambridge Isotope laboratories) was used as the solvent.

Thermal property of the synthesized monomers and polymers was characterized by a DSC 2920 (TA Instruments, New Castle, Del.), and the scan was carried out from 0° C. to 300° C. at a heating rate of 10° C./min and nitrogen gas flow rate of 25 mL/min. TA Universal Analysis ^{TM} software was used for thermal data analysis. The melting point (Tₘ) was determined at the onset of the melting endotherm. The glass transition value (T_{g}) was obtained as an average of the onset and end values.

The number and weight averaged molecular weights (Mₙ & M_{w}) and molecular weight distributions (MWD) of the PCL-based PEEAs were determined by Model 510 gel permeation chromatography (Waters Associates Inc. Milford, USA) equipped with a high-pressure liquid chromatographic pump, a Waters 486 UV detector and a Waters 2410 different refractive index detector. Tetrahydrofuran (THF) was used as the eluent (1.0 mL/min). The columns were calibrated with polystyrene standards having a narrow molecular weight distribution.

Synthesis of monomers. Three different types of di-p-nitrophenyl esters of dicarboxylic acids, NA, NS and NF, were used as monomers I in this example to provide the carboxylic ester segment of the PCL-based PEEA. NF has unsaturated double bonds and hence unsaturated, while NA and NS are saturated monomers I.

Two PCL-diols of different molecular weights (Mₙ=530 Da and 1250 Da) were used in this example to synthesize di-p-toluenesulfonic acid salts of bis-L-phenylalanine diesters as monomers II, and these monomers are synthesized the first time and used as the monomers to provide the amino acid segment of AA-PEEA. Both salts had PCL with ether bonds in the segment.

The chemical structures of the di-p-toluenesulfonic acid salts monomers II, Phe-PCL530 and Phe-PCL1250, were all confirmed by FTIR and NMR spectra. These two monomers have the similar structure with the only difference in the segment length of PCL (530 Da vs. 1250 Da). Therefore, they have almost the same FTIR and NMR spectra. The FTIR spectra of both Phe-PCL530 and Phe-PCL1250 showed the ester group band around 1737 cm⁻¹ and ether group band around 1127 cm⁻¹. Their ¹H and ¹³C NMR spectra also shared the same characteristic peaks. Both monomers were obtained as white powders.

AA-PEEA Polymer Synthesis. As shown in FIG. 3—Scheme 3, six different types of new PCL-based PEEAs were synthesized by the solution polycondensation of different combinations of monomer I (Ia, Ib or Ic) and monomer II (IIa, or IIb). Excess triethylamine was used as the acid receptor for TosOH during the polymerization to regenerate free amino groups in the di-p-toluenesulfonic acid salt monomer II. Polymerization took place in a homogeneous phase and the AA-PEEA polymer obtained remained dissolved but became more viscous.

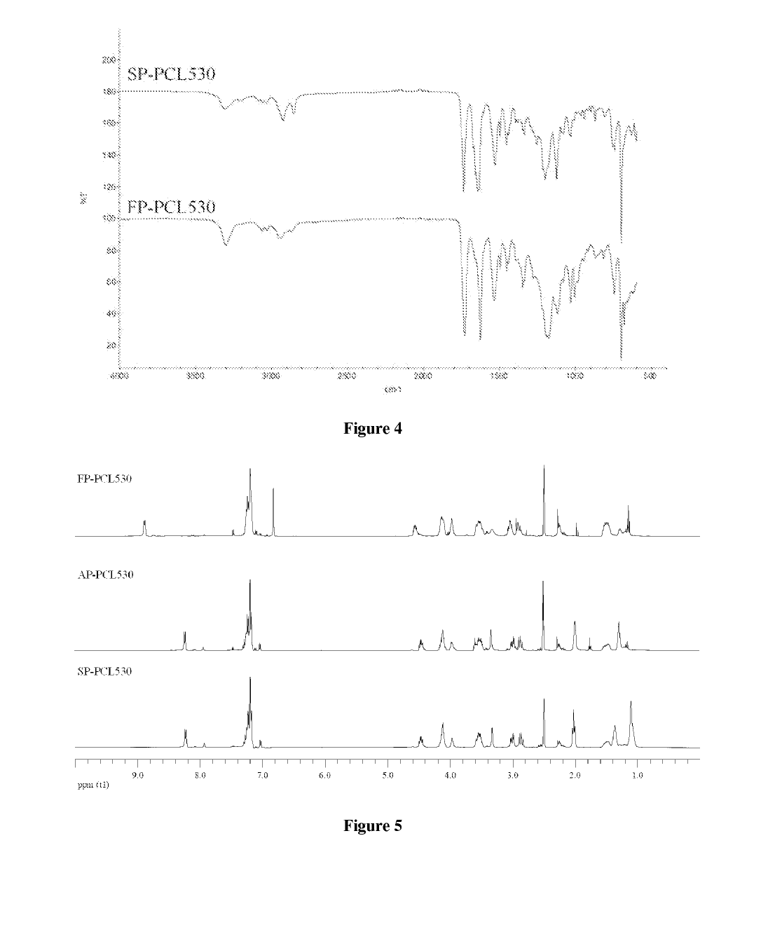

The structures of these AA-PEEAs were all confirmed by both IR and NMR spectra data. FIG. 4 shows 2 representative FTIR spectra of the AA-PEEAs (i.e., SP-PCL530 and FP-PCL530). Again, due to the similar structure of Phe-PCL530 and Phe-PCL1250, the polymers also shared the same characteristic IR peaks between AP-PCL530 and AP-PCL1250, SP-PCL530 and SP-PCL1250, or FP-PCL530 and FP-PCL1250. The products had the absorption bands of ester groups (˜1740 cm⁻¹), ether groups (˜1115 cm⁻¹) and amide groups (˜1640 cm⁻¹ and ˜1530 cm⁻¹), while fumaryl-based polymers (FP-PCL530 and FP-PCL1250) also showed unsaturated H—C═ bonds (˜3030 cm⁻¹).

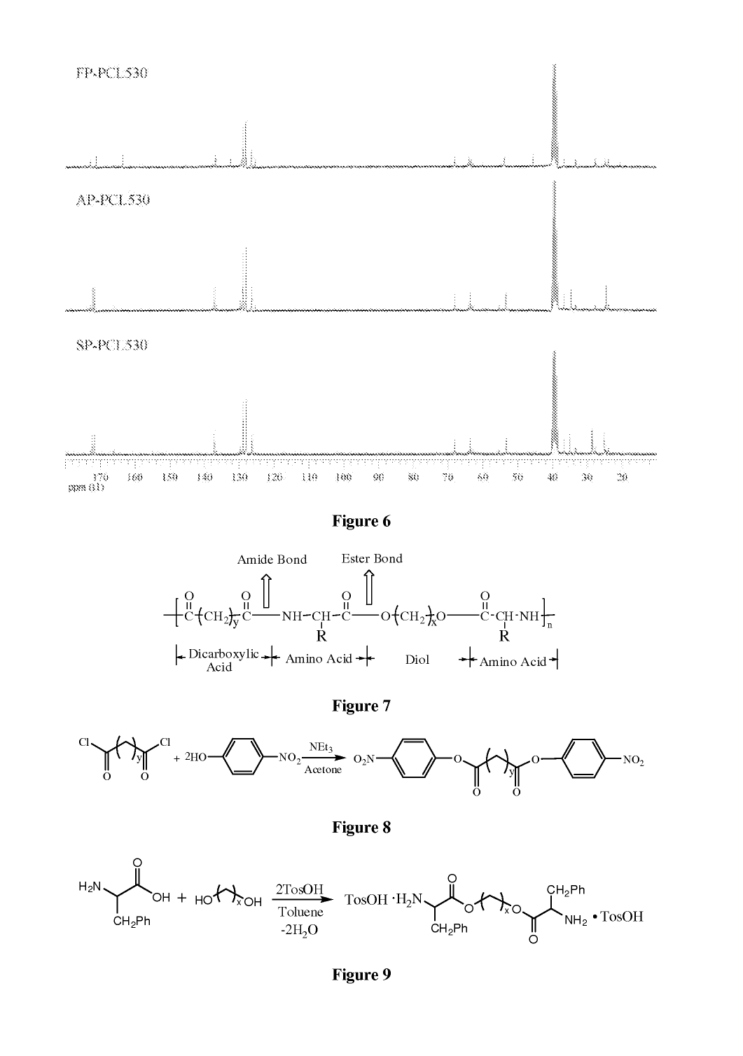

The NMR spectra (¹H and ¹³C) of the three AA-PEEAs based on PCL-diol (M_{w}=530 g/mol) are shown in FIGS. 5 and 6. The spectra data were fully in agreement with the anticipated chemical structure of the PCL-based AA-PEEA polymers shown in FIG. 3—Scheme 3. All the polymers showed ¹H peaks of the —NH— bonds of amide (8.88 or 8.24), the ether CH₂—O—CH₂ bonds in the diester unit (˜3.55) and —HC═ bonds in the amide unit (6.83) for fumaryl based AA-PEEAs. The ¹³C spectra contained all the peaks for every magnetically different carbon presented in the repeating unit of polymer.

Table 2 summarizes the fundamental property of the six PCL-based PEEAs synthesized. The PEEAs based on high MW PCL-diol were obtained in much higher yields (83%˜88%) than those based on low MW PCL-diol (38%˜51%), which could be due to the more loss of low MW PCL-diol based PEEA in the final purification step.

TABLE 2
Fundamental properties of PCL-based poly(ether ester amide)s^{a}

| | Yield | Mₙ | M_{w} | | T_{g} | Tₘ |
|---|---|---|---|---|---|---|
| | (%) | (kg/mol) | (kg/mol) | M_{w}/Mₙ | (° C.) | (° C.) |
| AP-PCL530^{b} | 45 | — | — | — | 22 | 75 |
| AP-PCL1250 | 88 | 5.6 | 7.4 | 1.33 | — | 56 |
| SP-PCL530 | 51 | 4.2 | 6.9 | 1.63 | 17 | 77 |
| SP-PCL1250 | 83 | 8.9 | 14.1 | 1.58 | — | 43 |
| FP-PCL530^{b} | 38 | — | — | — | — | — |
| FP-PCL1250 | 85 | 16.4 | 31.0 | 1.89 | — | 46 |

^{a}Synthesis conditions: C = 0.90 mol/l, T = 70° C., DMA as the solvent
^{b}Molecule weight data not available because the polymer cannot dissolved in THF which is the solvent for the casual GPC facility available to us.

The M_{w} of the polymer products varied from 6.9 kg/mol to 31.0 kg/mol. Considering PCL block in each of the polymer repeating unit (530 Da and 1250 Da), the degree of polymerization could be only about 5 to 20, which suggested the reactivity of these polycondensation reactions are not very high. The molecular weight data of the AP-PCL530 and FP-PCL530 samples, however, were not available because they did not have enough good solubility in THF, the designated eluent for the GPC characterization.

The glass-transition temperatures (T_{g}) and the melting points (Tₘ) of the synthesized PCL-based PEEAs were measured by DSC and listed in Table 2. Only AP-PCL530 and SP-PCL530 showed a clear glass-transition peak. AP-PCL530 has a higher T_{g} of 22° C. than SP-PCL530's 17° C., which suggested that the more rigid AP-PCL530's molecular backbone due to shorter methylene chain length in the diacid segment (x=2). Comparing the results from oligoethylene glycol based AA-PEEA, AP-PCL530's T_{g} is between T_{g} of AP3EG's (35° C.) and AP4EG's (14° C.) and SP-PCL530's T_{g} is between T_{g} of SP3EG's (23° C.) and SP4EG's (12° C.). These T_{g} data indicated the comparable chain flexibility between these two different types of AA-PEEAs, i.e., PCL-based AA-PEEA vs. oligoethylene glycol based AA-PEEAs. The relatively higher T_{g} of the PCL-based AA-PEEAs synthesized in this example (compared to non-amino acid-based PEEA synthesized from PCL-OH (Mₙ≅2 kDa), polyethylene glycol oligomer (PEG, Mₙ=150, 300 or 600 Da), trioxy and adipoyl dichloride that have T_{g}s as low as −50° C.—−58° C. due to a more flexible molecular structure with no pendant group) was attributed to the presence of pendant aromatic ring structure from the Phe amino acid in each repeating unit of the PCL-based AA-PEEA macromolecules.

All the PCL-based AA-PEEA polymers showed melting peaks, except FP-PCL530. The PCL-based AA-PEEA polymers having a shorter PCL segment (PCL530) showed a higher Tₘ (75˜77° C.) than the corresponding ones with a longer PCL segment, like PCL1250 (43˜56° C.), which is expected considering that a longer PCL segment resulted in the more flexible polymer chains. A longer PCL segment in the PCL-based AA-PEEA also reduces the density of amide and ester linkages along the polymer backbone, which, in turn, could reduce the extent of intermolecular hydrogen bond and reflect in a lower Tₘ. Tₘ range from the newly developed PCL-based AA-PEEA in this example is much larger than the narrow Tₘ range from the non-amino acid PCL-based PEEA which had a Tₘ range from 49˜51° C. and was lower than Tₘ of pure PCL (63° C.). When comparing with the oligoethylene glycol (OEG) based AA-PEEA and their copolymers, PCL1250-based PEEA still have a lower Tₘ, probably due to the high oxygen contents in oligoethylene-based AA-PEEA that the PCL1250 segment doesn't have, and these oxygen contents could provide intermolecular hydrogen bonds, i.e., higher Tₘ.

As shown in Table 3, the solubility of the PCL-based AA-PEEAs (50 mg) in common organic solvents (1.0 mL) at room temperature (25° C.) was evaluated. All the PCL-based AA-PEEAs are soluble completely in DMSO, DMF, trifluoroethanol, THF, and formic acid (except FP2EG), but cannot dissolve in water and ethyl acetate. Except AP-PCL530, the rest can also dissolve in chloroform. The two unsaturated PCL-based AA-PEEAs (FP-PCL530 and FP-PCL1250) share the similar solubility as saturated PCL-based AA-PEEAs in the regular organic solvents tested.

TABLE 3
Solubility of PCL-containing Amino Acid-based Poly(ether ester amide)
at Room Temperature (25° C.)

| | | Formic | | | | | | Ethyl | | |
|---|---|---|---|---|---|---|---|---|---|---|
| | H₂O | Acid | TFE | DMF | DMSO | THF | MeOH | Acetate | CHCl₃ | Acetone |
| AP-PCL530 | − | + | + | + | + | ± | ± | − | ± | − |
| AP-PCL1250 | − | + | + | + | + | + | ± | − | + | + |
| SP-PCL530 | − | + | + | + | + | + | ± | − | + | ± |
| SP-PCL1250 | − | + | + | + | + | + | ± | − | + | + |
| FP-PCL530 | − | + | + | + | + | ± | − | − | + | − |
| FP-PCL1250 | − | + | + | + | + | + | ± | − | + | + |

(+): Soluble;
(−): Insoluble;
(±): Partially soluble or swell.

For example, FPH, FPB and FP3EG, which have unsaturated fumaryl group in the polymer repeating units, cannot dissolve in most common organic solvents, except DMSO and DMF. The incorporation of PCL segment into unsaturated AA-PEEAs, however, improves their solubility in common organic solvents significantly when comparing with prior unsaturated AA-PEAs and AA-PEEAs. This significant improvement in solubility in the PCL-based AA-PEEAs could be attributed to the lower degree of polymerization of the PCL-based AA-PEEAs and their relatively high MW of the repeating unit so the polymer properties mainly depended on the PCL blocks. Such an improvement in solubility in common organic solvents would be beneficial for subsequent designing and fabrication of these new polymers for eventual commercial applications.

A series of biodegradable Phe amino acid-derived unsaturated and saturated poly(ether ester amide)s (AA-PEEAs) based on polycaprolactone-diol (PCL-diol) were successfully synthesized by solution polycondensation. The PCL-containing Phe-PEEA polymers can be obtained with yields ranged from 38% to 88% at 70° C. for 48 hrs in a DMA solvent. The molecular weights (Mₙ and M_{w}) measured by GPC could be as high as 31.0 kg/mol and with MWD of 1.89 for FP-PCL1250. The chemical structures of all the six PCL-containing Phe-PEEAs were confirmed by IR and NMR spectra. Two of the saturated PCL-containing Phe-PEEAs showed T_{g} much higher than that of PCL-based non-amino acid-based PEEAs reported with similar backbone structure. The most important advantage of these new PCL-containing Phe-PEEA polymers is their solubility in common organic solvents, particularly those unsaturated FP-PCL530 and FP-PCL1250, that can dissolve in chloroform, DMA and DMSO, formic acid and trifluoroethanol, while unsaturated AA-PEAs based on regular aliphatic diols or oligoethylene glycol based AA-PEEA could not dissolve in any of those common organic solvents. This solubility advantage could facilitate an easier design and fabrication of these new biomaterials for commercial applications.

With the presence of PCL segment in the molecule's backbone, these biodegradable and biocompatible AA-PEEAs may have more promising biomedical applications in tissue engineering, drug/gene delivery and wound healings as the new family of PCL-containing AA-PEEA integrate the known merits of the FDA-approved PCL biomaterial with the newly developed AA-PEEA. The biodegradability, mechanical properties and the feasibility as a drug/gene carrier for control release are currently still in progress and to be reported later.

### EXAMPLE 2

An example of a poly(ester amide) block copolymer synthesis, characterization, formulation, and in vitro cellular response.

A new biodegradable block copolymer family, poly(ester amide)-b-poly(ε-caprolactone) (PEA-b-PCL), were synthesized. The resulting copolymers have both desirable enzymatic biodegradation and hydrolytic degradation properties. These copolymers were synthesized by first preparing PEAs with free amine end groups via the solution polycondensation. These amine-terminated PEAs were used to initiate the ring opening polymerization of the ε-caprolactone for the synthesis of the PEA-b-PCL copolymers. The molecular weight of the PEA-b-PCLs block copolymers could be well controlled by adjusting the PEA molecular weight and weight ratio of ε-caprolactone and PEA. The obtained molecular weight ranged from 7 to 50 kg/mol. The structure and properties of the block copolymers and properties were characterized by various physicochemical methods, such as NMR, GPC, and solubility test. To test the processing capability of the polymers, PEA-b-PCLs were fabricated into different formulations, such as microspheres and electrospun fibers. The in vitro enzymatic biodegradation and some biological studies of PEA-b-PCLs were conducted to assess their biological property like supporting for cell attachment and proliferation, and inflammation. The preliminary biological data showed that these block PEA-PCL copolymers were nontoxic and the bovine aortic endothelial cells (BAEC) showed very good attachment, proliferation and low inflammation response. So the PEA-b-PCLs combined the favorable properties of PEA and PCL and expanded the potential applications in biomedical and pharmaceutical areas. The synthesis routes of PEA-b-PCL could be easily applied to other absorbable aliphatic polyesters to obtain a variety of PEA-b-polyesters.

A new approach of integrating absorbable aliphatic polyester with amino acid containing polymers is described in this example. Instead of using pure poly(amino acid)s to integrate with absorbable aliphatic polyesters, the amino acid-based poly(ester amide) (PEA, FIG. 7) is used here because of their well-known biological property, biocompatibility and enzymatic biodegradability. Amino acid based PEAs are a family of newly developed biodegradable and biocompatible polymers with ester and amide linkages on the backbones, and have shown very low inflammation response and controllable biodegradability. The PEA backbone consists of nontoxic building blocks like α-amino acids, fatty diols and dicarboxylic acids. The variety of combinations of these 3 building blocks offers many different generations of PEAs for different purposes. The incorporation of PEA into absorbable aliphatic polyesters (such as commercially available absorbable aliphatic polyesters) could be beneficial to both PEAs and absorbable aliphatic polyesters. To PEAs, the integration with aliphatic polyesters could bring hydrolytic degradation mode in addition to enzymatic biodegradation mode of PEAs. Such integration could also bring stronger mechanical property to PEAs. To aliphatic polyesters, the integration with PEAs could significantly improve the biological property of aliphatic polyesters, such as low inflammation and supporting cell growth. In addition, PEAs could bring useful functional groups like —COOH, —NH₂ to aliphatic polyesters which are well-known for the lack of functional groups.

In this example, the synthesis, characterization and properties of such a new hybrid block copolymer from aliphatic polyesters and amino acid-based PEAs (PEA-b-PCL) are reported. The resulting new hybrids could be fabricated into microspheres and electrospun fibrous membranes. These PEA-b-PCLs were also tested by many biological assays to determine their cellular responses, such as enzyme biodegradation, cell attachment, cell proliferation and in vitro inflammation assays. The biological data obtained suggest that these new hybrid copolymers were nontoxic to cells and the introduction of PEA into PCL could promote the cell attachment and proliferation, and significantly reduce the inflammation response of PCL.

Materials. L-Phenylalanine (L-Phe), p-toluenesulfonic acid monohydrate, adipoyl chloride, sebacoyl chloride, 1,4-butanediol, 1,6-hexaniol and p-nitrophenol were all purchased from Alfa Aesar (Ward Hill, Mass.) and used without further purification. ε-caprolactone, Tin (II) 2-ethylhexanoate (Sn(Oct)₂), Poly(ε-caprolactone) (PCL, Mₙ=80,000) were purchased from Aldrich and used directly. Poly(n-butyl methacrylate) (PBMA) was purchased from Polysciences® and used directly. Triethylamine from Fisher Scientific (Fairlawn, N.J.) was dried by refluxing with calcium hydride, and then distilled before use. Solvents like toluene, ethyl acetate, acetone; 2-propanol, dimethyl formamide (DMF) and dimethyl sulfoxide (DMSO) were purchased from VWR Scientific (West Chester, Pa.) and were purified by standard methods before use. Other chemicals and reagents if not otherwise specified were purchased from Sigma (St. Louis, Mo.).

α-Chymotrypsin (Type II, from bovine pancreas, 66 units/mg, solid) was purchased from Sigma Chemical Co. (St. Louis, Mo.) and chosen as the model enzyme because it could hydrolyze ester linkages at C-terminal of hydrophobic α-amino acids like L-phenylalanine. PBS buffer (0.1M, pH 7.4) was used for the biodegradation study of PEA-b-PCL block copolymers.

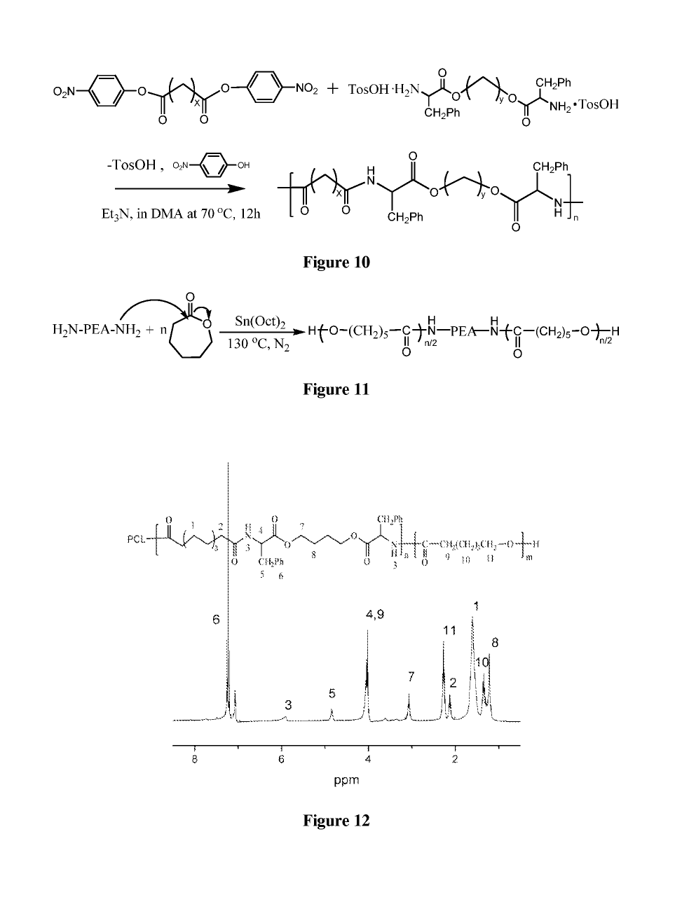

Experiments. The general scheme of the synthesis of PEA-b-PCL was divided into the following two major tasks: 1) the synthesis of poly(ester amide)s with free amine end groups via a solution polycondensation; 2) the synthesis of PEA-b-PCL block copolymers through the ring opening polymerization of ε-caprolactone via the initiation by the free amine end groups of the PEA. For the synthesis of PEA, two types of monomers were synthesized and then polycondensed in a solvent. The two monomers were: di-p-nitrophenyl ester of dicarboxylic acids (I) (FIG. 8), and tetra-p-toluenesulfonic acid salts of bis(L-phenylalanine), α,ω-alkylene diesters (II) (FIG. 9). These 2 monomers, I and II were then polycondensed into low molecular weight PEAs having free amine end groups (III) (FIG. 10). The details of the PEA monomers and polymer synthesis are known. The main difference from the know published procedures is the reaction time. In this example, the reaction time was short so that low molecular weight PEAs having free amine end groups could be obtained.

Synthesis of Monomers: Di-p-nitrophenyl Ester of Dicarboxylic Acids (I) and Di-p-toluenesulfonic Acid salt of Bis(L-Phenylalanine)Alkylene Diesters (II). Di-p-nitrophenyl esters of dicarboxylic acids were prepared by reacting dicarboxylic acyl chloride varying in methylene length with p-nitrophenol. Two monomers I were made in this example: di-p-Nitrophenyl Adipate (NA), x=4; and di-p-Nitrophenyl Sebacate (NS), x=8 (x indicates the numbers of methylene group in the diacid). The preparation of di-p-toluenesulfonic acid salt of bis(L-phenylalanine)alkylene diesters was carried out based on previously described methods. Two monomers II were made in this example: tetra-p-toluenesulfonic acid salt of his (L-arginine) butane diesters, Phe-4, x=4, and tetra-p-toluenesulfonic acid salt of bis(L-arginine)hexane diesters, Phe-6, x=6.

Synthesis of PEA (III) by Solution Condensation of (I) and (II). PEAs were prepared by the solution polycondensation of the above monomers I and II (Phe-4, Phe-8 and NA, NS) at different combinations and molar ratios. The PEAs synthesized are summarized in Table 4 and are labeled as x-Phe-y, where x and yare the number of methylene group in diacid and diol, respectively. In this example, each type of PEA was made at two different molecular weights, one at 4-5,000; and another at 7-9,000.

An example of the synthesis of 8-Phe-4 of number average molecular weight (Mₙ) around 4,000 via solution polycondensation was given here. Monomers NS (0.8 mmol) and Phe-8 (1.0 mmol) in 1.5 mL of dry DMSO were mixed well and the mixture solution was then heated up to 75° C. under magnetic bar stiffing to obtain a uniformed mixture. Triethylamine (0.31 mL, 2.2 mmol) was added drop by drop to the mixture at 75° C. with vigorous stiffing until the complete dissolution of the monomers. The solution became viscous and the color turned into yellow within several minutes. The reaction vial was then kept for 12 hrs at 75° C. in a thermostat oven without stiffing. The resulting PEA polymer was precipitated from the reaction solution by adding 300 mL cold ethyl acetate, and the product was purified by Soxhlet extractor using ethyl acetate as solvent for 24 hours. The final dried Phe-PEA products are yellow or pale yellow solid and dried in vacuum at room temperature.

TABLE 4
Phe-PEAs prepared by different combination of monomers I and II

| | Monomer II, y = 4 | Monomer II, y = 6 |
|---|---|---|
| Monomer I, x = 4 | 4-Phe-4 | 4-Phe-6 |
| Monomer I, x = 8 | 8-Phe-4 | 8-Phe-6 |

Synthesis of Phe-PEA-b-PCL. The PEA-bPCL block copolymers were synthesized by the ring-opening polymerization of ε-caprolactone (ε-CL) using the free NH₂ end groups of Phe-PEA as the macro-initiator with Sn(Oct)₂ as the catalyst (FIG. 11). In this report, all PEAs used for preparing PEA-b-PCL were phenylalanine based PEAs. The polymerization was carried out in a 100 mL 3-neck round bottom flask under dry nitrogen atmosphere at 130° C. The details of all the prepared PEA-b-PCLs are summarized in Table 4.

An example of the synthesis of 8-Phe-4-b-PCL from 8-Phe-4 of Mₙ 4,000, and ε-caprolactone at the 8-Phe-4 to ε-CL weight feed ratio of 1 to 6 is given here. 8-Phe-4 (2.00 g) and ε-CL (12.00 g) were added into a 100 mL 3-neck round bottom flask under dry nitrogen atmosphere. The catalyst, Sn(Oct)₂, was dissolved in dried THF to make a 10 wt % solution and was added to the reaction mixture with a weight ratio of 1:500 [Sn(Oct)₂ to ε-CL]. Then, the temperature of the flask was increased to 130° C. under slow magnetic bar stiffing and the duration time for the polymerization is 16 hours. After that, the final solid product was dissolved in chloroform and precipitated in cold ethyl ether, purified twice, and the final product (white-yellow solid powder) was dried under vacuum at room temperature to constant weight. The yield is around 90-95%.

Characterization. The physicochemical properties of the prepared monomers and polymers were characterized by various standard methods. For Fourier transform infrared (FTIR) characterization, the samples were ground into powders and mixed with KBr at a sample/KBr ratio of 1:10 (w/w), FTIR spectra were then obtained with a Perkin-Elmer (Madison, Wis.) Nicolet Manna 560 FTIR spectrometer with Omnic software for data acquisition and analysis. NMR spectra were recorded with a Varian (Palo Alto, Calif.) Unity Inova 400-MHz spectrometer operating at 400 for ¹H NMR. Deuterated chloroform (CHCl3-d; Cambridge Isotope Laboratories, Andover, Mass.) with tetramethyisilane as an internal standard or deuterated dimethyl sulfoxide (DMSO-d₆; Cambridge Isotope Laboratories) was used as the solvent. MestReNova software was used for the data analysis.

The solubility of the polymers in common organic solvents at room temperature was assessed by using 10.0 mg/mL as a solubility standard to determine whether a polymer was soluble or not in a solvent. The thermal properties of the synthesized PEA-b-PCLs were characterized with a DSC 2920 (TA Instruments, New Castle, Del). The measurements were carried out from −30 to 200° C. at a scanning rate of 10° C./min and at a nitrogen gas flow rate of 25 mL/min. TA Universal Analysis software was used for thermal data analysis.

The number-average molecular weight (Mₙ), weight-average molecular weight (M_{w}), and polydispersity (MWD) of the synthesized PEAs and PEA-b-PCLs were determined with a model 510 gel permeation chromatograph (GPC, Waters Associates, Inc., Milford, United States) equipped with a high-pressure liquid chromatography pump, a Waters 486 UV detector, and a Waters 2410 differential refractive index detector. Tetrahydrofuran (THF) was used as the eluent (1.0 mL/min). The columns were calibrated with polystyrene standards with a narrow MWD.

The static contact angle of the polymers was measured by a Ramé-Hart Model 500 Advanced Goniometer/Tensiometer. The round micro cover glasses (diameter, 12 mm, no. 2, VWR, West Chester, Pa.) were coated with the polymer in DMF solutions (2 wt %) and vacuum drying before testing. The static contact angle was measured by dropping the distilled water (4 μL) on the polymer coated surface. Each polymer coating was measured for triple times.

Formulation of PEA-b-PCL into Microspheres. PEA-b-PCL microspheres were formulated by an oil-in-water (O/W) emulsion/solvent evaporation technique. For the PEA-b-PCL used here, the PEA was from 8-Phe-4 with Mₙ of 4,000, and the feed weight ratio of 8-Phe-4/ε-CL was 1:6). A predetermined amount of PEA-b-PCL polymer was first dissolved in 5.0 mL dichloromethane (DCM) or chloroform. The resultant polymer solution was then poured rapidly into 100.0 mL of aqueous PVA solution with a predetermined concentration. The O/W emulsion was achieved by a thorough stirring with a homogenizer (PowerGen Model 35, Fisher Scientific) at 10,000 or 20,000 rpm for 5-10 min. The emulsified system was then stirred with a magnetic stirrer for the evaporation of the organic solvent (DCM or chloroform) for 3 hours, the dispersed microdroplets finally solidified in the aqueous PVA solution. The microspheres were washed by the distilled water three times to remove residual PVA and then collected by centrifugation (13,000 rpm). After the microspheres were freeze-dried in a Labconco FreeZone Benchtop Freeze Dry System (Kansas City, Mo.) under vacuum at −48° C. for 72 hours, they were stored in a refrigerator at 4° C. for the future characterizations and tests.

Formulation of Phe-PEA-b-PCL into Microfibers by Electrospinning Method. A mixed solvent of chloroform and DMF with a weight ratio of 4.0 (chloroform/DMF) was used to dissolve the PEA-b-PCL to form a 20 wt % polymer solution. For the PEA-b-PCL used here, the PEA was from 8-Phe-4 with Mₙ of 4,000, and the feed weight ratio of 8-Phe-4/ε-CL was 1:6). The polymer solution was delivered by a programmable pump (Harvard Apparatus, MA) to the exit hole of the electrode (needle with a hole having a diameter of 0.7 mm). The flow rate was set at 50.0 μL/min. A positive high-voltage supply (Glassman High Voltage Inc.) was used to supply the voltage in a range of 15-20 kV. The fibers were collected on a collection plate. The distance of electric field (from the electrode to collector) was fixed at 120 mm Scanning electron microscopy (SEM) was used to examine the surface morphology of PEA-b-PCL microspheres and electrospun fibers. The dried microsphere or fiber samples were fixed on aluminum stubs and coated with gold under vacuum for 30 s for SEM observation (Leica 5440, Germany).

In vitro enzymatic biodegradation of PEA-b-PCL. Polymer film samples (around 200 mg, round shape and same thickness) was added into a small vial containing 10 mL of PBS buffer (pH=7.4, 0.1 M) with 0.2 mg/mL of α-chymotrypsin. The mixture was then incubated at 37° C. with a constant reciprocal shaking (ca. 100 rpm). At the end of predetermined period, the polymer film samples were removed by filtration, then washed with distilled water for 3 times, and dried in vacuum at 35° C. for 24 hours to completely remove the residue water. The immersion media were refreshed at every test time and every 48 hours in order to maintain the enzymatic activity. The degree of biodegradation was estimated from the weight loss of the polymer based on the following equation:

Wₜ(%)=(Wo−Wₜ₎/W_{O}×100

Where W_{O} is the original weight of the dry polymer sample before immersion and Wₜ is the dry polymer sample weight after incubation for t hours/days (with or without enzyme). The average weight loss of three specimens was measured for each sample.

Cell Culture. The interaction of PEA-b-PCLs with cells was preliminarily studied to determine the level of cell attachment, proliferation and inflammation. Bovine Aorta Endothelial Cells (BAEC) was used as the model cells for attachment and proliferation tests. BAEC were purchase from VEC Technologies and maintained at 37° C. in 5% CO₂ in Medium 199 (Invitrogen, Carlsbad, Calif.) supplemented with 10% Fetal Clone III (HyClone, Logan, Utah), and 1% each of penicillinstreptomycin, MEM amino acids (Invitrogen, Carlsbad, Calif.), and MEM vitamins (Mediatech, Manassas, Va.). BAECs were used from passages 8-12. J774 mouse peritoneal macrophages were used as the model cells for in vitro inflammation response tests, which were obtained from ATCC and cultured at 37° C. in 5% CO₂ in DMEM supplemented with 10% FBS. J774s were used from passage 5-10. For all the cells, the cell media was changed every 2 days. Cells were grown to 70% confluence before splitting or harvesting.

Cell Attachment and Proliferation on PEA-b-PCL. The evaluation of the endothelial cell attachment and proliferation capability on the PEA-b-PCL surface was performed by cell proliferation assay followed by MTT assay for cytotoxicity. The round micro cover glasses (diameter, 12 mm, no. 2, VWR, West Chester, Pa.) were coated with polymer DMF solution (2 wt %) and vacuum drying. The following polymers were tested: PCL, PEA-b-PCL, mixtures of PEA and PCL. For the PEA-b-PCL used here, the PEA was from 8-Phe-4 with Mₙ of 4,000, and the feed weight ratio of 8-Phe-4/ε-CL was 1:6. Commercial available PBMA was selected as the control. After drying, the polymer-coated glass coverslips were placed onto the bottom of the 24-well cell culture plates and were sterilized for overnight under a UV irradiation before use.

Cells at an appropriate cell density concentration (20,000 cells/well) were seeded onto each test well in 24-well plates (BD Falcon™, polystyrene treated) and then incubated in a 37° C., 5% CO₂ incubator. Cell media was changed every day. After the predetermined periods (48 hours and 96 hours), the cell culture plates were removed from the incubator. Cell morphology was recorded under an optical microscope. The media from the wells were then aspirated, and 0.5 mL fresh media were added to each well. After that, 40 μL of MTT solution (5 mg/mL) was subsequently added to each well, followed by 4 hour incubation at 37° C., 5% CO₂. The cell culture medium was carefully removed and 400 μL of acidic isopropyl alcohol (with 0.1 M HCl) was added to dissolve the formed formazan crystals. The plate was slightly shaken for 30 mins and 100 μL solution was transferred from each well to a 96 well cell culture plate. Optical density (OD) of each well was measured at 570 nm (subtract background reading at 690 nm) by using a microplate reader.

In vitro Measurement of Inflammatory Response of PEA-b-PCL. J774 macrophages were seeded at 10,000 cells/well onto 12 mm polymer-coated glass coverslips in 24-well tissue culture plates. A plain glass coverslip was used as a negative control. Positive controls were glass coverslips in media containing Lipopolysaccharide (LPS, from E. coli 0111:B4, Sigma-Aldrich, St. Louis, Mo.) at final concentrations of 1.25 μg/mL and 5 μg/mL. A plain glass coverslip in media alone was used as a cell-free negative control. PEA-b-PCL (PEA was from 8-Phe-4 with Mₙ of 4,000, and the feed weight, ratio of 8-Phe-4/ε-CL was 1:6 was selected for this test. PCL and PBMA were used as polymer control. Macrophage activation after 48 hours incubation was measured using an ELISA kit to measure mouse TNF-α release (Invitrogen, Carlsbad, Calif.) according to the manufacturer's suggested protocol and N=3. TNF-α concentrations were calculated from a standard curve using a 4-parameter standard curve-fitting algorithm (Gen5 software, BioTek Instruments, Winooski, Vt.). All samples and controls were read in duplicate on a 96-well plate reader at 450 nm and referenced against a chromogen blank.

Statistics. Where appropriate, the data are presented as mean±standard error of the mean calculated over at least three data points. Significant differences compared to control groups were evaluated by unpaired Student's t-test or Dunnet test at p 0.05, and between more than two groups by Tukey's test with or without one-way ANOVA analysis of variance. JMP software (version 8.0, from SAS Company) was used for data analysis.

Synthesis and Characterization of PEAS with Functional End Groups. In this example, four types of monomers (two monomers I, NA, NS; and two monomers II, Phe-4 and Phe-6) were synthesized using know procedures for preparing PEA with free amine end groups. All these monomers were prepared with high yields and easily purified by recrystallization. The chemical structure and purity had been confirmed by ¹H NMR, FTIR and DSC. All the data were consistent with the published data.

Unlike the previously reported Phe-PEAs, which had higher molecular weight (Mₙ 25-30 kg/mol measured by GPC in THF) and less active end groups, in this example, Phe-PEAs with active end amine groups and controlled molecular weight (MW) were required as a macro-initiator to successfully prepare the PEA-b-PCL via ring-opening polymerization.

H₂N-PEA-NH₂ was prepared according to the reaction scheme in FIG. 10. Based on the Carothers Equation [Xn=(1+r)/(1+r−2rp)], the molecular weight and end functional groups of polymers made from polycondensation method could be affected or controlled by the following parameters: the molar ratio between 2 monomers (r=monomer II/monomer I in this example), reaction temperature (T) and time (t), catalyst type and its concentration, monomer concentration, etc. For example, according to the Carothers Equation, if the molar ratio r was changed, the MW of the prepared PEA would be affected and the end groups could be controlled. For examples, if r=1.0, the molecular weight will be maximum and the end groups would be one free amine group and one acid group; if r>1.0, the molecular weight will decrease with the increasing of r value, and the end groups would be 2 free acid groups; if r<1.0, the molecular weight will decrease with the decreasing of r value, and the end groups would be 2 free amine groups. The details of the relationship between r and end groups are summarized in Table 5. All these reaction parameters were intensively studied, and it was found that r and t were key factors affecting the PEA MW and end functional groups. In this example, we only focused on r, the other parameters were fixed at the same values as those in a known study. After optimization, the reaction conditions are: reaction temperature: 70° C.; concentration of each monomer: 1.0-1 5 mmol/mL; the reaction medium: DMA; catalyst (acid acceptor): NEt₃, reaction time: 6 hours. For r, after optimization, it was found that the MW and end functional groups have the following relationships with r as shown in Table 6. In Table 6, the Phe-PEAs used to make PEA-b-PCL are 8-Phe-4 with r value equals to 0.8 and 0.9.

In this example, all the prepared Phe-based PEAs have 2 free NH₂ end groups and hence the subsequent PEA-b-PCL synthesized are A-B-A type (A: PCL; B, PEA) block copolymer. All the PEAs are prepared with high yields (>80%) under the optimized reaction conditions. For the chemical structure identification of the prepared Phe-PEAs, the structure was confirmed by DSC, ¹H-NMR and FTIR spectra.

TABLE 5
Relationship between r and end groups of Phe-PEAs

| r value | End groups of Phe-PEAs |
|---|---|
| =1.0 | One NH₂ group and one COOH group |
| >1.0 | Two COOH groups |
| <1.0 | Two NH₂ groups |

TABLE 6
Information of Phe-PEAs

| PEA | | Reaction | Mₙ | End Functional | |
|---|---|---|---|---|---|
| Name | r | Time (h) | (kg/mol) | groups | Yield (%) |
| 4-Phe-4 | 0.8 | 8 h | 3.5-4.5 | 2 NH₂ end groups | 85 |
| 4-Phe-4 | 0.9 | 8 h | 7-8 | 2 NH₂ end groups | 87 |
| 4-Phe-6 | 0.8 | 8 h | 3.5-4.5 | 2 NH₂ end groups | 93 |
| 4-Phe-6 | 0.9 | 8 h | 7-8 | 2 NH₂ end groups | 84 |
| 8-Phe-4 | 0.8 | 8 h | 3.5-5 | 2 NH₂ end groups | 91 |
| 8-Phe-4 | 0.9 | 8 h | 7-9 | 2 NH₂ end groups | 89 |
| 8-Phe-6 | 0.8 | 8 h | 3.5-5 | 2 NH₂ end groups | 85 |
| 8-Phe-6 | 0.9 | 8 h | 7-9 | 2 NH₂ end groups | 83 |

Synthesis and Characterization of PEA-b-PCL. As shown in FIG. 11, the PEA-b-PCLs were prepared by ring-opening polymerization of ε-carprolactone with H₂N-PEA-NH₂ as the macro-initiator and Sn(Oct)₂ as catalyst. The polymerization conditions were optimized and it was found that the following conditions were good for the PEA-b-PCLs copolymer synthesis: reaction temperature: 130° C.; polymerization duration time: 16 hours; molar ratio of catalyst to monomer=1:500; N₂ protection. The chemical structure and molecular weight of the new copolymers were characterized and confirmed by ¹H-NMR (FIG. 12) and GPC (Table 7). FIG. 12 showed an example of the ¹H-NMR spectrum of PEA-b-PCL (8-Phe-4-b-PCL synthesized from 8-Phe-4 of Mₙ 4.1 k and PEA/ε-CL=1:1, w/w); all the ¹H-NMR peaks of PEA-b-PCL were identified, and the integration area ratios were consistent with the calculated theoretical ratios. The ¹H-NMR peaks marked with numbers from 1 to 11 are assigned to the corresponding protons of 8-Phe-4-b-PCL as shown in FIG. 12.

For the GPC data, the GPC traces are unimodal with no signal of coexisting low or high molecular weight species that may be produced from uncontrolled polycondensation. It was found that a successfully prepared PEA-b-PCL copolymer only showed one main GPC peak; if the polymerization was failed or did not complete, the GPC would show two or more peaks. For the two peak case, one peak was from PCL and the other one was PCL-b-PEA, which were observed when the weight ratio of ε-CL to PEA was too large or the Mₙ of PEA was too big. For example, when the PEA of Mₙ about 35 kDa reacted with ε-CL monomer under the same condition, most of the ε-CL would form PCL homopolymer and only small parts of ε-CL would react with PEA.

The key factors for the successful PEA-b-PCL synthesis are the MW and end functional NH₂ groups of the H₂N-PEA-NH₂. It was found that if the Mₙ of H₂N-PEA-NH₂ was greater than 15 kg/mol, the side reaction would happen during the synthesis of PEA-b-PCL and significant amounts of byproducts existed in the final product, which could not be separated from the PEA-b-PCL. The majority of the byproduct was PCL prepared from the polymerization of ε-CL monomers without PEA initiation. All these evidences have strongly supported the anticipated molecular structure of PEA-b-PCL.

Many types of PEA-b-PCL were prepared and some examples were given in Table 7. The data in Table 7 indicate that an increase in the feed weight ratio (WR) of ε-CL/H₂N-PEA-NH₂ in the ring polymerization would lead to an increase in the Mₙ of the PEA-b-PCL obtained and was consistent with the calculated theoretical Mₙ. The theoretical Mₙ is calculated according the Mₙ of H₂N-PEA-NH₂ and the feed weight ratio of ε-CL/H₂N-PEA-NH₂. The assumption for this theoretical Mₙ is that all ε-CL react with H₂N-PEA-NH₂ When the feed WR reached certain values, the Mₙ of PEA-b-PCL would also reach a peak value and a further increase in feed ratio, however, didn't result in higher MW PEA-b-PCL. For example, for 8-Phe-4 of Mₙ 4,000, the feed weight ratio limit is 10. The peak Mₙ values of PEA-b-PCL were found to be affected by the Mₙ of H₂N-PEA-NH₂. For example, for 8-Phe-4 with Mₙ of 7-9,000, the peak Mₙ of PEA is around 50 kg/mol. The type of H₂N-PEA-NH₂, however, did not show any obvious effect on such a molecular weight relationship. For this phenomenon, it's reasonable that the prepared PEA-b-PCL ‘s MW has some limitations because if the WR of ε-CL/H₂N-PEA-NH₂ is too high, the polymerization will need longer time; and density of the active NH₂ is not high enough, then ε-CL could be polymerized without the initiation from the NH₂ of PEA. All the MWD of PEA-b-PCL is around the range of 1.30-1.60, which is similar to the MWD of Phe-PEA.

TABLE 7
Information of PEA-b-PCLs

| | Mₙ | PEA/ε- | | | | |
|---|---|---|---|---|---|---|
| PEA | (KDa/ | CL | Mₙ | Mₙ | | Yield |
| Name | mol) | (w/w) | (theoretical) | (measured) | MWD | (%) |
| 8-Phe-4 | 4.1 | 1:1 | 8.2 | 7.7 | 1.42 | 85 |
| 8-Phe-4 | 4.1 | 1:3 | 16.4 | 17.2 | 1.55 | 87 |
| 8-Phe-4 | 4.1 | 1:6 | 28.4 | 31.6 | 1.37 | 93 |
| 8-Phe-4 | 4.1 | 1:8 | 36.9 | 32.0 | 1.36 | 81 |
| 8-Phe-4 | 7.7 | 1:1 | 15.4 | 14.7 | 1.45 | 85 |
| 8-Phe-4 | 7.7 | 1:2 | 23.1 | 23.7 | 1.41 | 91 |
| 8-Phe-4 | 7.7 | 1:3 | 30.8 | 28.8 | 1.59 | 89 |
| 8-Phe-4 | 7.7 | 1:6 | 53.9 | 45.6 | 1.50 | 94 |
| PCL | 80.0 | NA | NA | NA | NA | NA |

Solubility. The solubility of PEA-b-PCL can greatly affect their potential biomedical applications. All the PEA-b-PCL polymers synthesized in this example were insoluble in non-polar or weak polar solvent like ether and ethanol; but soluble in polar organic solvent like chloroform, DMF and THF (Table 8). The PEA-b-PCL copolymers did not show significant solubility difference from either the PEA or PCL. Among all the PEA-b-PCL copolymers, they did not show significant difference in the solubility property, even though these copolymers had different types of PEAs and feed weight ratio to PCL. This is because the solubility difference between PCL and x-Phe-y PEA is not big. The PEA-b-PCLs showed similar solubility as the pure PCL since the majority part of the copolymer is PCL. When compared with 8-Phe-4, 8-Phe-4-b-PCLs dissolved in acetone; while 8-Phe-4 could not.

TABLE 8
Solubility of PEA-b-PCLs*

| PEA-b- | | | | | | | |
|---|---|---|---|---|---|---|---|
| PCL | Ethyl | | | | | | |
| MW | ether | Ethanol | Acetone | THF | Chloroform | DMF | DMSO |
| 7.7 | − | − | + | + | + | + | + |
| 17.2 | − | − | + | + | + | + | + |
| 31.6 | − | − | + | + | + | + | + |
| PCL | − | − | + | + | + | + | + |
| 8-Phe-4 | − | − | − | + | + | + | + |

*The PEA-b-PCLs are all 8-Phe-4-b-PCL (Mₙ of 8-Phe-4 is around 4,000;
+ means soluble, − means insoluble

Static Contact Angle. The contact angle of 8-Phe-4, PCL, and PEA-b-PCL (8-Phe-4 with Mₙ of 4,000. and the feed weight ratio of 8-Phe-4/ε-CL=1:6) were measured and compared (Table 9). It was found that all three types of polymers showed high water contact angles around or above 80 degree and the contact angle of PEA and PCL are consistent with the reported data. The contact angle is the angle formed by a liquid at the three phase boundary where the liquid, gas, and solid intersect. The small contact angle means that the adhesive forces are dominating, while the high contact angle means the cohesive forces are dominating. Based on the obtained contact angle data, the introduction of PEA into the PCL backbone brought about 10% reduction in wettability from pure PCL (from 90.86 to 81.58°. The contact angle of the 8-Phe-4-b-PCL, however, is only marginally higher than the pure 8-Phe-4.

TABLE 9
static contact angle of polymers

| | Polymer Name | | |
|---|---|---|---|
| | PCL | 8-Phe-4 | PEA-b-PCL (1) |
| Static Angle (o) | 90.86 ± 0.77 | 79.62 ± 1.03 | 81.58 ± 0.94 |

Thermal Property of PEA-b-PCLs. The reported melting temperature (Tₘ) and glass transition temperature (T_{g}) of pure PCL are around 64-65° C. and −60° C. respectively. For pure Phe-based PEA of Mₙ 25,000-30,000, such as 8-Phe-4, the Tₘ and T_{g} are around 111° C. and 47° C. respectively. For the 8-Phe-4-b-PCL, no obvious T_{g} peaks could be detected in the DSC scanning range from −30° C. to 150° C.

TABLE 10
Tₘ and T_{g} of polymers

| Polymer Name | Tₘ | T_{g} |
|---|---|---|
| PCL | 64-65° C. | −60° C. |
| 8-Phe-4 | 111° C. | 47° C. |
| 8-Phe-4-b-PCL (⅓,w/w) | 55° C. | NA |
| 8-Phe-4-b-PCL (⅙,w/w) | 60° C. | NA |
| 8-Phe-4-b-PCL (⅛,w/w) | 63° C. | NA |

Note:
The thermal data of PCL and 8-Phe-4 are previously reported values.

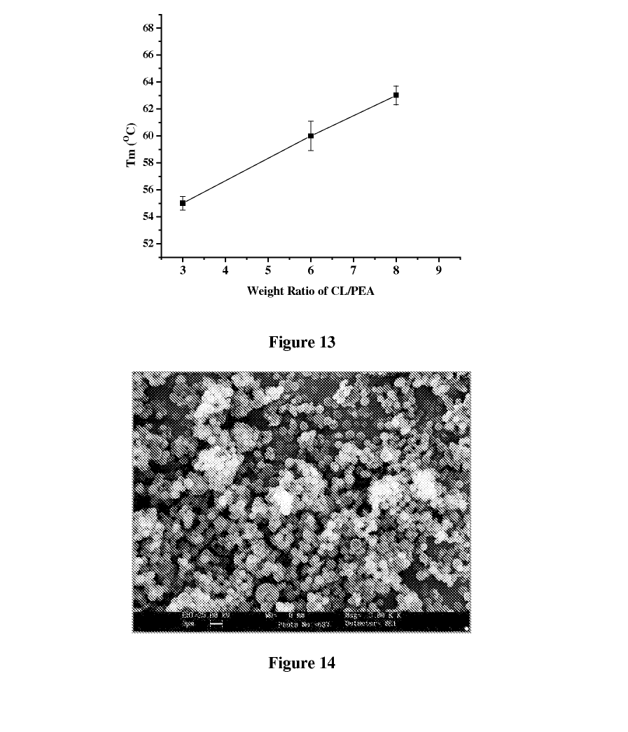

It was found that PEA-b-PCL could have 2 Tₘ peaks from PCL part and PEA part respectively. And the Tₘ values for PEA (8-Phe-4) part are: 98-100° C. for PEA with Mₙ around 4,000; and 110-112° C. for PEA (8-Phe-4) with Mₙ around 7-9,000. The thermal data indicated that the Tₘ values of PEA (8-Phe-4) part are mainly affected by the Mₙ of PEA. However, the Tₘ peak from the PCL part was found that it was significantly affected by the copolymer composition. FIG. 13 and Table 10 showed an example that how the block copolymer composition affected the Tₘ of PCL part. Pure PCL and 3 types of PEA-b-PCL were selected for Tₘ comparison. All of the PEA-b-PCL were 8-Phe-4-b-PCL and Mₙ of 8-Phe was 4.1 k. The only difference is that the weight ratio of ε-CL/8-Phe-4 was from 3.0 to 6.0 and 8.0. The data in FIG. 13 show that the Tₘ value of the PCL part in the 8-Phe-4-b-PCL copolymer increased with an increase in the feed weight ratio of ε-CL/8-Phe-4 and this composition effect on the T_{g} is consistent with the reported polyester systems.

Formulation of PEA-b-PCL into Microspheres and Electrospun Fibers. In order to test the processing capability of these newly synthesized PEA-b-PCL copolymers, two fabrications methods, microspheres and electrospun micro/nano fibers, were used.

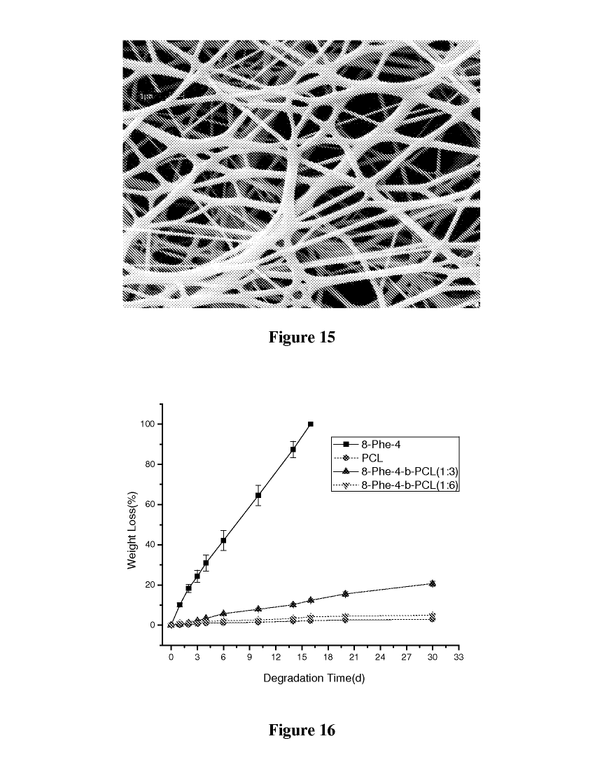

FIG. 14 is an example for the PEA-b-PCL (PEA was from 8-Phe-4 with Mₙ of 4,000, and the feed weight ratio of 8-Phe-4/ε-CL=1:6) microspheres with a diameter around 1-2 μm. For the microsphere fabrication, the following different parameters were examined: polymer concentration, PVA concentration, and homogenizer speed. The optimized conditions for the PEA-b-PCL microspheres are: 1 wt % PVA in 100 mL water; 10 wt % polymer in 10 mL CHCl₃; homogenizer speed: 10,000 rpm for 5-8 minutes. FIG. 15 is an example for the PEA-b-PCL electrospun micro/nano fibers with a fiber diameter around 0.3-1 μm. The fiber fabrication conditions were also optimized. From FIGS. 14 and 15, we could state the new PEA-b-PCL copolymers could be fabricated into different physical forms.

In vitro Enzymatic Biodegradation of PEA-b-PCL. Four types of polymer films were selected for the enzymatic biodegradation study: 8-Phe-4 (Mₙ=30,000), PCL (Mₙ=80,000), 8-Phe-4-b-PCL (Mₙ of 8-Phe-4: 4,000; PEA/ε-CL=1:3, w/w), 8-Phe-4-b-PCL (Mₙ of 8-Phe-4: 4,000; PEA/ε-CL=1:6, w/w). FIG. 16 showed the enzymatic biodegradation results of the 4 polymers during the one month period. The weight loss data show that the pure PCL film as expected did not biodegrade during the 1 month period, while the 8-Phe-4 film was completely biodegraded within 2 weeks and the linear biodegradation curve suggested that the biodegradation mechanism of 8-Phe-4 was of surface erosion mechanism. For the 2 types of 8-Phe-4-b-PCL, both of them showed smaller weight loss than the pure 8-Phe-4, but higher than the pure PCL. The 8-Phe-4-b-PCL copolymer having a higher PCL component (i.e., PEA/ε-CL=1:6, w/w), the block copolymer film showed almost no degradation, just like the pure PCL. With relatively more PEA component (PEA/ε-CL=1:3, w/w); the block copolymer film showed almost the same weight loss pattern as the pure PCL. The Phe-PEA could be biodegraded by α-chymotrypsin within a few days or several weeks, and the degradation rate depends on the enzyme concentration and the physical form of the PEAs (powder, particle or solid film). The data was consistent with the reported biodegradation behavior of Phe-PEA. The weight loss data also showed that an introduction of PCL into PEA did significantly alter the enzymatic biodegradation property of PEA, and the resulting PEA-b-PCL's degradation property became closer to PCL, and the level of change depended on the PEA to PCL feed ratio during the copolymer synthesis.

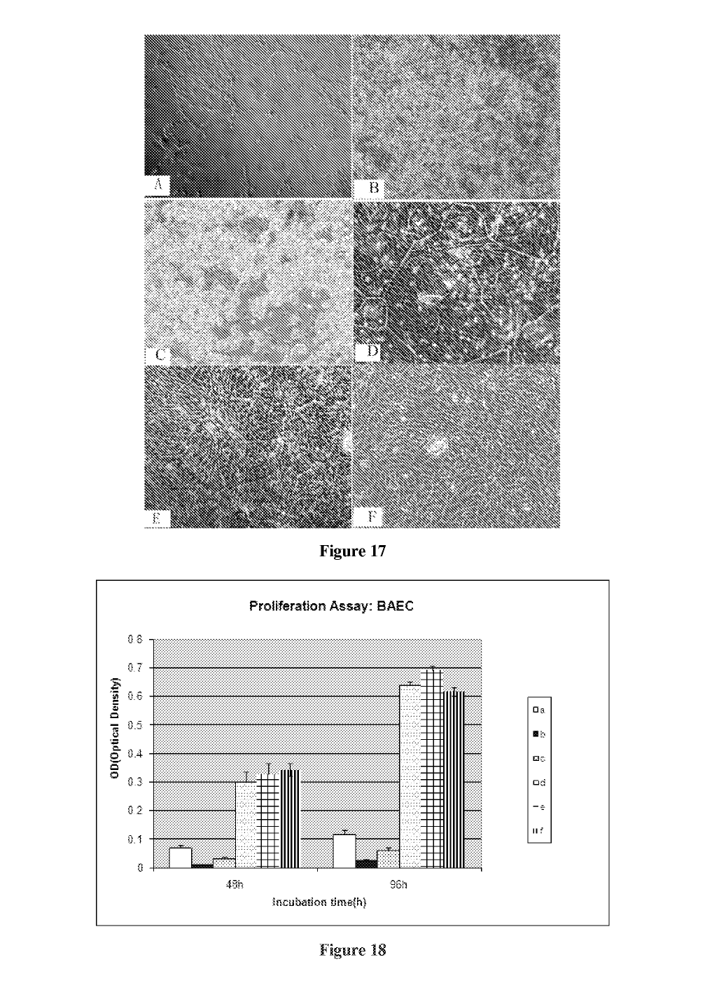

Cell Attachment and Proliferation Assays. Six types of polymers and their copolymers and mixtures were tested here. They are: pure PCL, PEA/PCL (8-Phe-4 with Mₙ of 4,000; at the mixing ratio of 1:3; w/w), PEA/PCL (8-Phe-4 with Mₙ of 4,000; at the mixing ratio of 1:6; w/w), PEA-b-PCL (8-Phe-4 with Mₙ of 4,000,PEA/ε-CL=1:3; w/w), PEA-b-PCL (8-Phe-4 with Mₙ of 4,000, PEA/ε-CL=1:6; w/w), and pure PEA (8-Phe-4, Mₙ=30,000). The pure PEA and PCL were used as the controls. From microscopic cell morphology images (FIG. 17), it was found that after coating on the glass coverslips, the mixture of PEA/PCL could not form a good coating with smooth or well organized surface. Meanwhile, the pure PEA or PCL could form a good and smooth coating. For the PEA-b-PCL, the copolymer coating showed some organized microstructure, which could be due to the self-assembly happened during the drying process. The self-assembly of the copolymers was induced because of the chemical difference of the PEA and PCL segments toward dissolution and drying processes. This surface microstructure of the PEA-b-PCL copolymers had been confirmed by many repeated trials.

The data in FIG. 17 and the MTT assay (FIG. 18) show that this self-assembly of PEA-b-PCL copolymers did not affect BAEC cell attachment/proliferation. FIG. 17 showed that the PEA-b-PCL copolymers could significant increase cell attachment and proliferation when compared to pure PCL, almost reaching the same level as pure Phe-PEA. For PCL, the cell attachment was not as good as pure 8-Phe-4 and other coatings. For the PEA/PCL mixture, the cell attachment was poor when comparing to PEA-b-PCL. Many types of PEA coatings could promote the cell attachment and proliferation, while pure PCL was not a very good material for this purpose. For example, Amato et al reported the poor human osteoblasts attachment on pure PCL surface, while the introduction of functional groups, such as amine groups, could significantly improve the human osteoblasts attachment performance on modified PCL surface. The above results indicated that the cell attachment and proliferation performance of PCL could be significantly improved by introducing the PEA segments into PCL chain. The cell data also showed that the PEA-b-PCL copolymers have totally different cellular response from the PEA/PCL mixture. These data suggest that a simple coating of the PEA/PCL mixture could not improve the cellular response of PCL.

A comparison of the cell data among PEA-b-PCL, pure PCL and pure PEA shows that the cell data are consistent with the contact angle data (Table 9). For the pure PCL, the contact angle is around 91°, while 8-Phe-4 and 8-Phe-4 have the contact angles of 79° and 81°, respectively. 8-Phe-4 has showed excellent cell attachment and proliferation performance. The chemical incorporation of 8-Phe-4 into PCL significantly changed the surface property of PCL (i.e., reduce its contact angle from 91° to 81°), and significantly improved the cell attachment and proliferation performance of PCL. The 8-Phe-4-b-PCL has a similar contact angle as the pure 8-Phe-4, so it's not surprising that both polymers showed similar good cell attachment and proliferation performance.

For the proliferation tests, an increase in cell number results in an increase in the amount of MTT formazan formed and an increase in UV absorbance. FIG. 18 showed that the PCL and the PEA/PCL mixture could not support the bovine aortic endothelial cell (BAEC) proliferation well, while PEA-b-PCL and pure PEA could support the cell proliferation pretty well, and the PEA-b-PCL copolymers showed almost the same proliferated cell # as the pure PEA did. Thus, the chemically incorporation of PEA into PCL could significantly promote the cell proliferation of PCL-based biomaterials.

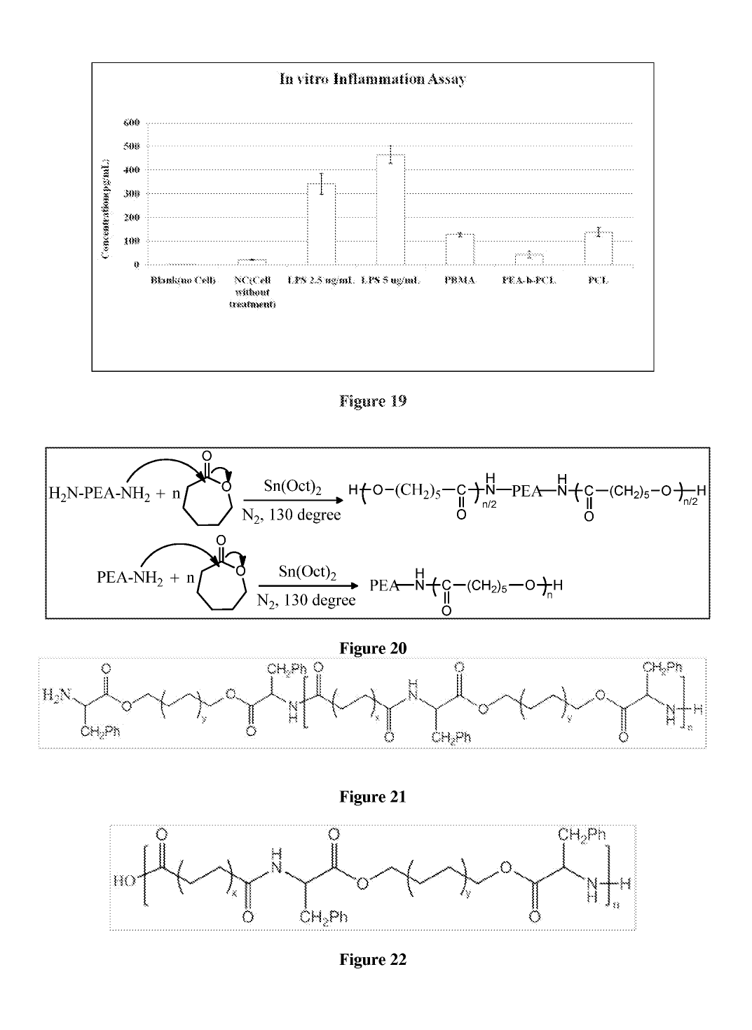

In vitro Inflammatory Response of PEA-b-PCL. In this example, macrophage activation after 48 hours incubation was measured using an ELISA kit to test mouse TNF-α production so that a quantitative inflammatory response could be determined. The PEA-b-PCL copolymer tested was synthesized from 8-Phe-4 with Mₙ of 4,000 at the PEA/ε-CL=1:6; w/w. PMBA was used here as a control because it's a widely used FDA approved polymer in medical devices like drug-eluting stents. The in vitro inflammatory data show that PEA-b-PCL copolymer had a significantly lower level inflammation response than PBMA and PCL control. For example, from FIG. 19, the PEA-b-PCL show only 40 pg/mL TNF-α production by J774 mouse macrophages from 150 pg/mL TNF-α of a pure PCL, a reduction to less than ⅓ of the original TNF-α production of a pure PCL. For the pure PCL, Ainslie et al reported the PCL films would exhibit inflammatory response, although less than the lipopolysaccharide (LPS). Others reported that the chemical modification of PCL, such as PLA-b-PCL-b-PEG, could decrease the PCL inflammation response to moderate level In this example, the PEA modification of PCL (PEA-b-PCL copolymer) also significantly reduced the inflammation of pure PCL. It is important to know that the inflammatory data in FIG. 19 also indicate that the PEA incorporated as a co-monomer unit into a copolymer has the capability to tame the inflammatory response induced by other relatively inflammatory biomaterials like PCL in this example. The very low inflammatory response to pure PEA-based biomaterials was also reported in other in vitro and in vivo studies. Therefore, PEAs not only show very low level of inflammation by themselves but also could tame the inflammatory response induced by other biomaterials when PEAs are conjugated with other biomaterials. This unique biological property may have important impact on the developing low inflammatory biomaterials and medical devices.

A new biodegradable block copolymer family, PEA-b-PCL, has been successfully prepared and characterized. In a certain range, the molecular weight and polymer structure of PEA-b-PCLs could be well estimated and controlled. PEA-b-PCLs could be easily fabricated into different formulations, such as microspheres and electrospun fibers. Enzyme degradation tests showed that introducing PEA to PCL did not significantly change the degradation behavior of PCL. Cell attachment and proliferation tests showed that the PEA segment in the PEA-b-PCL could greatly increase the cell attachment and proliferation performance of PCL, and could reach the same level as the PEA. The in vitro inflammation response test also proved that the PEA-b-PCL had low inflammation response. So the PEA-b-PCLs combined the favorable properties of PCL and PEA and expand the applications in the biomedical and pharmaceutical areas. The synthesis route of PEA-b-PCL could be easily applied to other polyester systems to obtain a variety of PEA-b-Polyesters.

### EXAMPLE 3

An example of PEA-aliphatic block copolymers.

An integration of PEA and aliphatic polyester (APE) into a single polymer molecule can expand the properties and utility beyond PEA and APE alone. The integrated polymers can be biodegraded by enzyme and water as well, while PEAs are biodegraded by enzymes only, and APE are degraded by water only. The integrated polymers could have broader processing capability in terms of solvents and temperatures. The integrated polymers could have more semi-crystalline structure and property that pure PEAs don't normally have after processing.

Basic concept is to use the free amine end groups of low MW PEA macromers as nucleophiles, e.g., H₂N-PEA-NH₂. These H₂N-PEA-NH₂ nucleophiles can then initiate ring-opening polymerization with aliphatic polyester (APE) monomers like glycolide, lactide, caprolactone. The resulting polymers are block copolymers of PEA and APE.

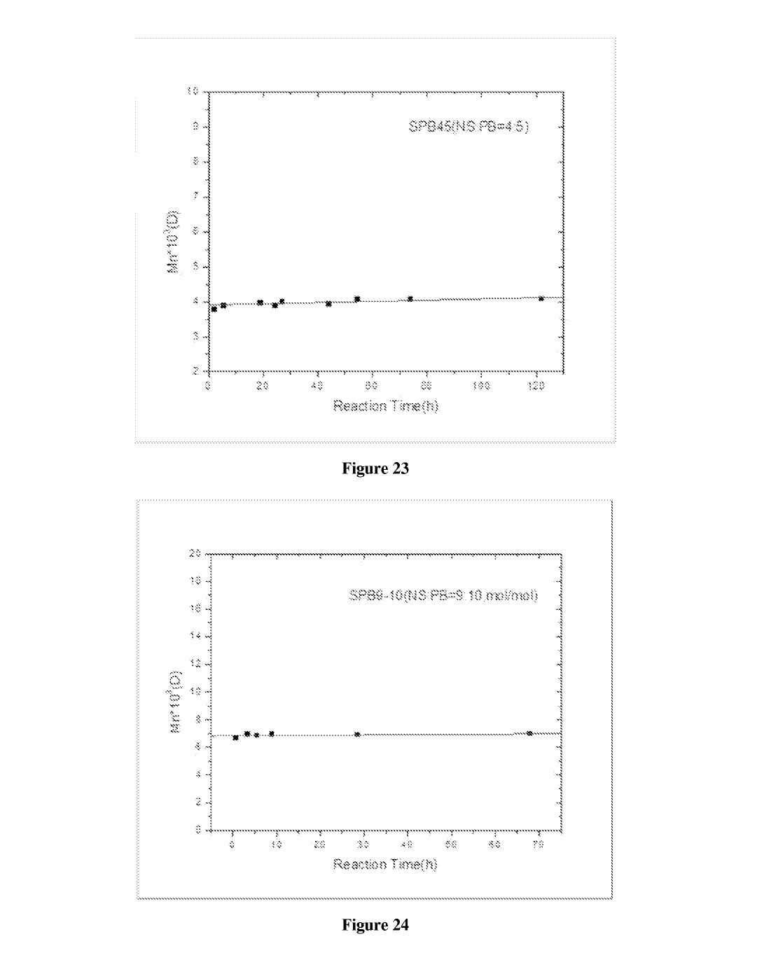

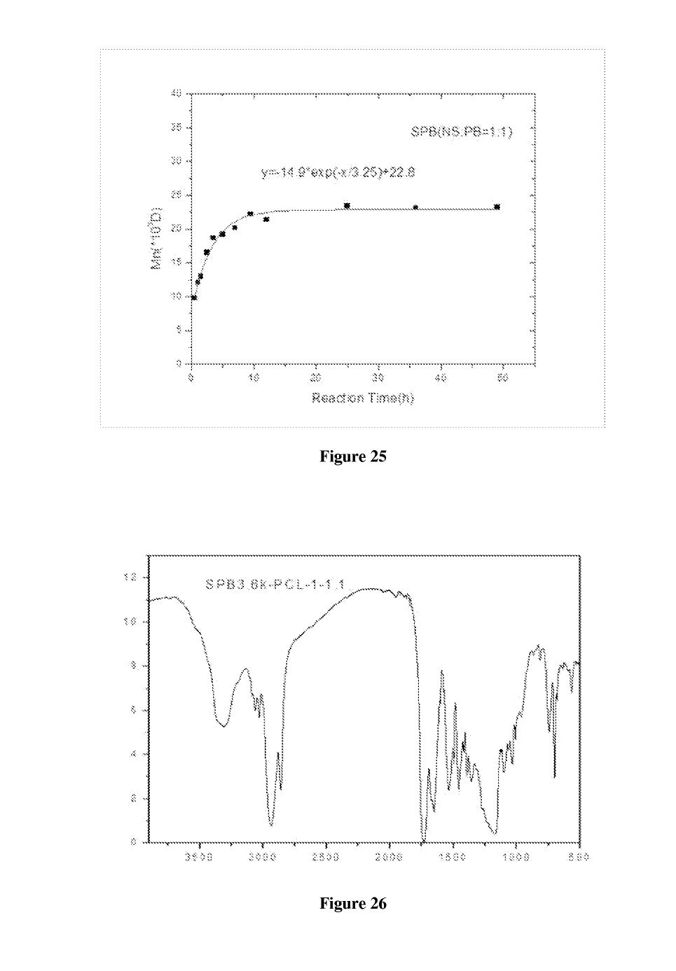

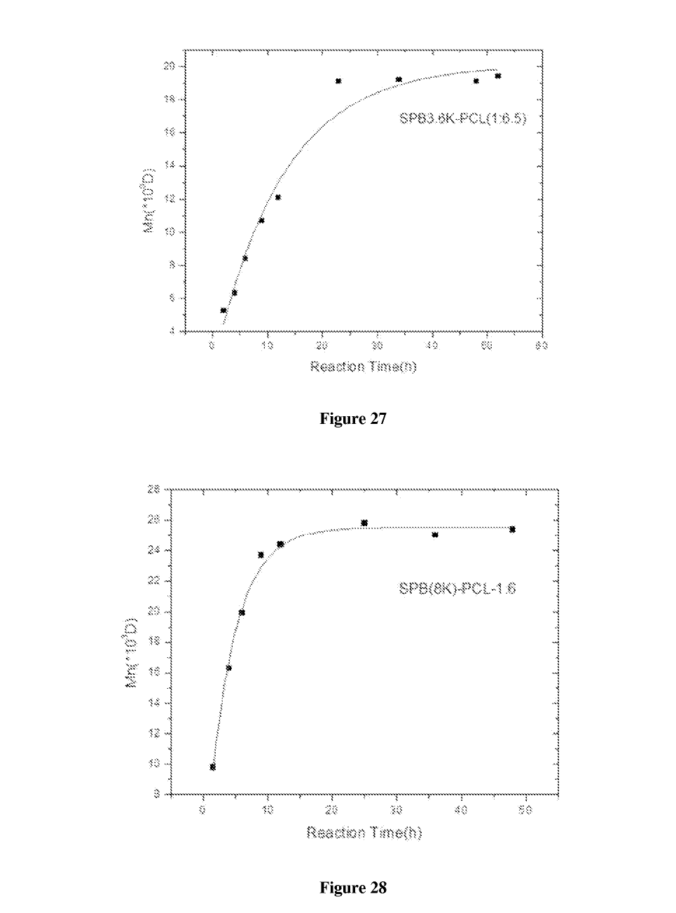

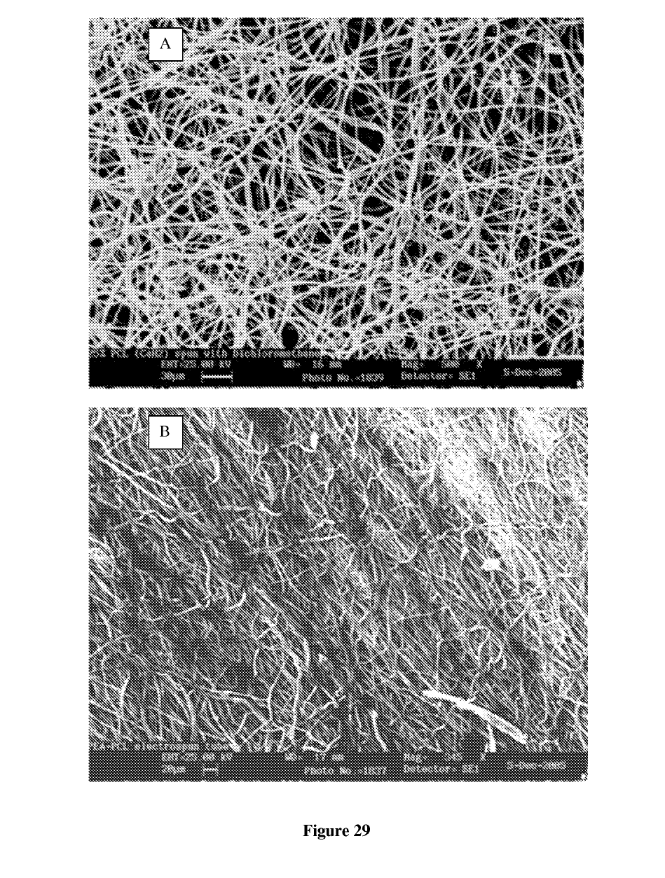

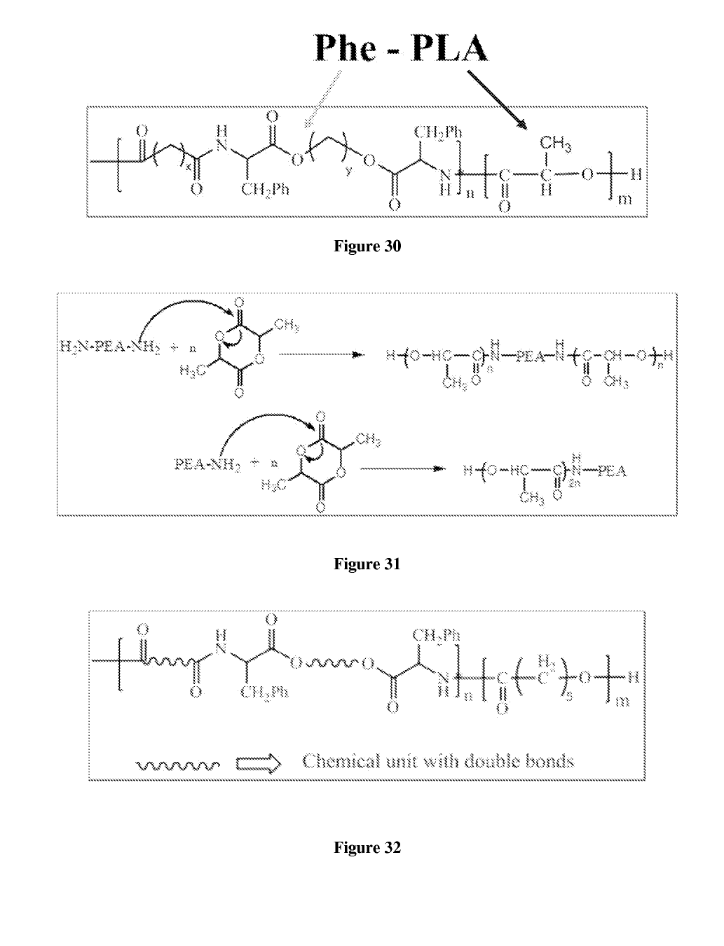

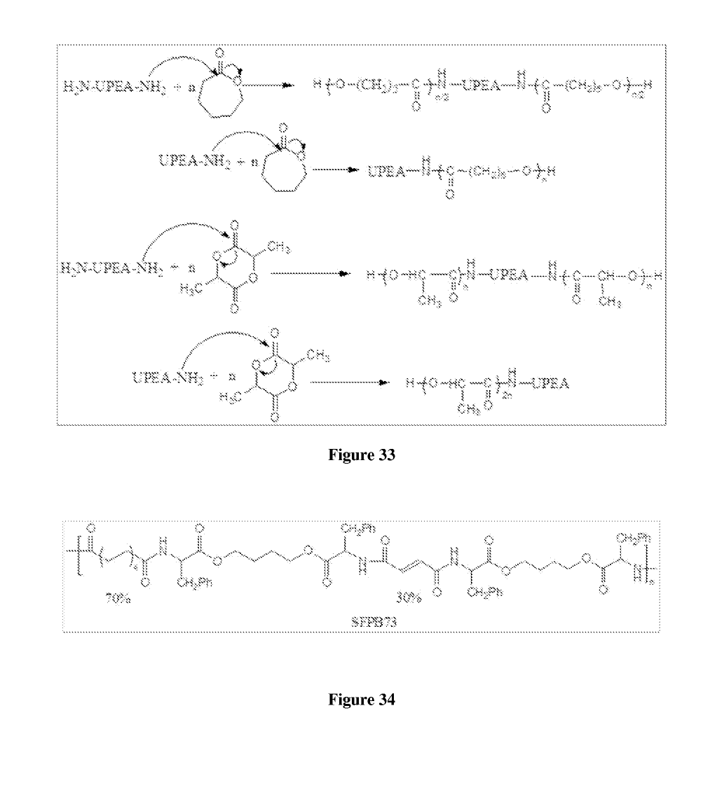

By controlling the feed molar ratio of H₂N-PEA-NH₂ macromer to aliphatic polyester (APE) monomers, and the available free amine end groups in low MW PEA macromers, PEA/APE copolymers (PEA-b-APE) with a wide range of chemical, physical, thermal, mechanical, biodegradation, and biological properties can be synthesized. For example, a 7-member ring caprolactone is used as aliphatic polyester monomer. PCL is poly-ε-caprolactone. Based on the available free amine end group in PEA macromer, 2 types of block PEA/PCL copolymers could be made: PCL-PEA-PCL (from PEA with 2 amine end groups) and PEA-PCL (from PEA with one amine end group). FIGS. 20-34 relate to this example.

PEA tested: Phenylalanine-based saturated and unsaturated PEA (Phe) used as the low MW PEA macromer nucleophiles, H₂N-PEA-NH₂. Aliphatic polyesters tested: poly-ε-caprolactone (PCL) and poly-L-lactide (PLLA and PDLLA).

Synthesis of Low MW PEAs with Free Amine End Groups. Based on the following theory or facts, low MW PEA macromers with free amine end groups are obtained.

1, Carothers Equation: Xₙ=(1+r)/(1+r−2*r*p), low MW PEA macromer can be prepared by using low r value. Note: p=conversion percentage of monomers; Xn=degree of polymerization; r=moles of limiting reagent/moles of excess reagent.

2, The low MW PEA macromers can also be obtained by ending the polymerization early.

3, If excessive amount of monomer of di-p-toluenesulfonic acid salt of bis (α-arginine), α,ω-alkylene diester (offering the diol and amino acid part in the PEA chain), there will be free amine groups at two ends of PEA macromer chain. (H₂N-PEA-NH₂).

4, If r=1 and the polymerization was ended early, there will be free amine groups at one end. (PEA-NH₂).

Conclusion for Low MW PEA. Low MW PEA macromer with one (PEA-NH₂) or two (H₂N-PEA-NH₂) free amine end groups can be prepared by changing the polymerization recipe and conditions. These functional low MW PEA macromers can be used to prepare different types of PEA-b-APE copolymers.

TABLE 11
Effects of PEA macromer MW and PEA to Caprolactone Monomer
Feed Weight Ratio on MW of PCL-PEA-PCL copolymers.

| | Mn of PEA | | Reaction | | Yield | Mn | Mw | Mp | |
|---|---|---|---|---|---|---|---|---|---|
| # | (8-Phe-4) | T(° C.) | Time (h) | W_{PEA}:W_{CL} | (%) | (10³) | (10³) | (10³) | D |
| 1 | 3.6K | 140.0 | 24 | 1:1.1 | 92% | 7.71 | 13.2 | 12.7 | 1.72 |
| 2 | 3.6K | 140.0 | 24 | 1:3.5 | 95% | 23.2 | 36.0 | 43.2 | 1.54 |
| 3 | 3.6K | 140.0 | 24 | 1:6 | 97% | 31.6 | 45.6 | 45.6 | 1.45 |
| 4 | 3.6K | 140.0 | 24 | 1:9 | 93% | 31.0 | 50.7 | 50.0 | 1.63 |
| 1a | 8.0K | 140.0 | 24 | 1:2 | 92% | 23.7 | 32.2 | 37.8 | 1.36 |
| 2a | 8.0K | 140.0 | 24 | 1:3 | 95% | 28.8 | 39.1 | 43.9 | 1.36 |
| 3a | 8.0K | 140.0 | 24 | 1:6 | 98% | 43.6 | 65.3 | 58.7 | 1.50 |

The MW of copolymer increase with the increasing of weight ratio (molar ratio) of ester monomer/PEA. The final products are PCL-8-Phe-4-PCL For sample #1-4, r=0.8; for sample 1a-3a, r=0.9.

Solubility of PCL-8-Phe-4-PCL. PCL-8-Phe-4-PCL (r=0.8 for 8-Phe-4, W_{PEA}/W_{CL}=1:1.1 to1:6.5,w/w). Insoluble in: Water, Ether, 1-Propanol, 2-propanol, Ethanol, Methanol; Soluble in: Chloroform, Dichloromethane, THF, Acetone, Ethyl Acetate, Acetonitrile, DMF, DMSO and DMA.

PEA-b-APE Copolymers can be fabricated into a variety of physical forms (e.g., microspheres and electrospun fibrous membranes).

TABLE 12
Effect of PEA Macromer to Lactide Monomer Feed Weight Ratio on
PLA-PEA-PLA Copolymers MW

| | Mₙ of PEA | T | Reaction | | Yield | Mₙ | M_{w} | Mₚ | |
|---|---|---|---|---|---|---|---|---|---|
| # | (8-Phe-4) | (° C.) | time (h) | WPEA:WLA | (%) | (10⁻³) | (10⁻³) | (10⁻³) | D |
| 1 | 3.6k | 140 | 24 | 1:3 | 92% | 10.2 | 14.3 | 13.7 | 1.40 |
| 2 | 3.6k | 140 | 24 | 1:6 | 93% | 15.7 | 21.7 | 17.9 | 1.38 |
| 3 | 3.6k | 140 | 24 | 1:9 | 90% | 14.9 | 20.7 | 16.3 | 1.38 |

The MW of PLA-PEA-PLA copolymers increase with increasing lactide monomer to PEA macromer weight ratio (molar ratio). PEA macromer: 8-Phe-4@3.6K MW, r value=0.8. Solubility of PLA-8-Phe-4-PLA. PLA-8-Phe-4-PLA (r=0.8 for 8-Phe-4, WPEA/WLA=1:3 to1:9,w/w). Insoluble in: Water, Ether, 1-Propanol, 2-propanol, Ethanol, Methanol; Soluble in: Chloroform, Dichloromethane, THF, Acetone, Ethyl Acetate, Acetonitrile, DMF, DMSO and DMA.

TABLE 13
UPEA-b-PCL (UPEA:SFPB)

| | | # of end | | | | | | | |
|---|---|---|---|---|---|---|---|---|---|
| | | amino | | Reaction | | Mn | Mw | Mp | |
| # | PEA | groups | T (° C.) | Time (h) | W_{PEA}:W_{CL} | (10³) | (10³) | (10³) | D |
| 1 | SFPB4410 | 1/2 | 140-5 | 16 | 1:6 | 27.6 | 44.8 | 46.9 | 1.63 |
| | Insoluble in THF | | | | | | | | |
| 2 | SPFB73(0.95:1) | 1/2 | 140-5 | 16 | 1:6 | 26.9 | 39.2 | 44.6 | 1.46 |
| | Mw = 4k, soluble | | | | | | | | |
| | in THF | | | | | | | | |

A new family of block copolymers having both PEA and aliphatic polyester segments were developed, e.g., PEA-b-APE. This new family of PEA-b-APE copolymers requires the availability of low MW PEA macromers having either two or one free amine end groups. The end group of PEA macromers can be controlled by changing the feed molar ratio of toluenesulphonic diester salt to nitrophenol. A lower nitrophenol to diester salt feed molar ratio (r<1) leads to PEA macromers having 2 free amine end groups. PEA-b-APE copolymers can be prepared by reacting this kind of PEA macromer with conventional APE monomers like glycolide, lactide, caprolactone. The resulting PEA-b-APE copolymers can be fabricated into a variety of physical forms like microspheres and electrospun fibrous membranes. The relationship between MW and weight ratio of PEA macromer to APE monomer was examined for the synthesis of PEA-b-APE copolymers

While the invention has been particularly shown and described with reference to specific embodiments (some of which are preferred embodiments), it should be understood by those having skill in the art that various changes in form and detail may be made therein without departing from the spirit and scope of the present invention as disclosed herein.

What is claimed is:

1) A copolymer having the following structure:
PEA-APE or APE-PEA-APE,
wherein PEA is a PEA block and APE is an aliphatic polyester block, and the PEA block has terminal amine groups and a molecular weight of 3,000 g/mol to 10,000 g/mol.

2) The copolymer of claim 1, wherein the copolymer has the following structure: 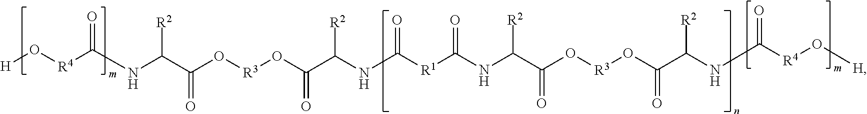
wherein n is an integer from 1 to 100; m, at each occurrence in the copolymer, is an integer from 0 to 100, and m is 1 in at least one occurrence in the copolymer,
R¹ at each occurrence in the copolymer is alkyl group or alkenyl group comprising 2 to 20 carbons;
R² at each occurrence in the copolymer is a hydrogen, an alkyl group comprising 2 to 8 carbons, alkenyl group comprising from 2 to 8 carbons, alkynyl group comprising 2 to 8 carbons, carbocyclic group, where the carbocyclic ring comprises 3 to 8 carbons, or alkyl amino group, where the alkyl moiety of the alkyl amino group comprises 1 to 8 carbons,
R³ at each occurrence in the polymer is an (C₁-C₈) alkyl group, (C₂-C₈) alkenyl group, or alkyl polyether group, and
R⁴ at each occurrence in the copolymer is an aliphatic group comprising 1 to 8 carbons, including all integer numbers of carbons, or a polyether group.

3) The copolymer of claim 2, wherein R⁴ is an alkyl group comprising 1 to 6 carbons.

4) The copolymer of claim 2, wherein R⁴ is an alkyl group comprising 5 carbons.

5) The copolymer of claim 2, wherein R¹ is a C₄ or C₈ alkyl group.

6) The copolymer of claim 2, wherein R² is a benzyl group.

7) The copolymer of claim 2, wherein R³ is a C₄ or C₆ alkyl group.

8) The copolymer of claim 2, wherein the copolymer has the following structure:

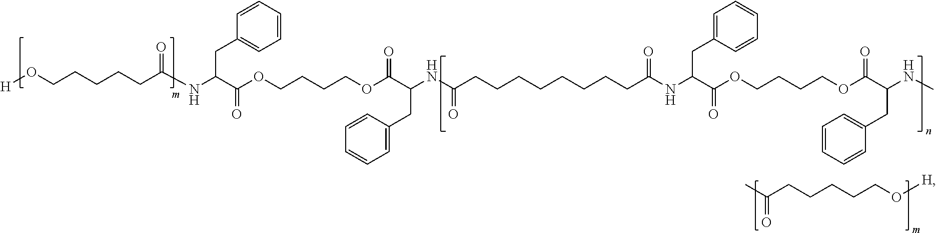

9) The copolymer of claim 1, wherein the copolymer has a molecular weight of 2000 g/mol to 100,000 g/mol.

10) The copolymer of claim 1, wherein the copolymer has a molecular weight of 5000 g/mol to 60,000 g/mol.

11) A composition comprising the copolymer of claim 1.

12) The composition of claim 11, wherein the copolymer is present as a fiber or microsphere.
